(19) United States
(12) Patent Application Publication
(10) Pub. No.: US 2009/0271695 A1
(43) Pub. Date: Oct. 29, 2009

(54) METHOD OF ACCESSING OR MODIFYING A PART OF A BINARY XML DOCUMENT, ASSOCIATED DEVICES

(75) Inventors: Herve Ruellan, Rennes (FR); Franck Denoual, Saint Domineuc (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/429,909

(22) Filed: Apr. 24, 2009

(30) Foreign Application Priority Data
Apr. 25, 2008 (FR) 0852827
Feb. 11, 2009 (FR) 0950862

(51) Int. Cl. G06F 17/20; G06F 17/30

(52) U.S. Cl. 715/227; 707/100; 715/234; 707/E17.044

(57) ABSTRACT

The present invention concerns methods of accessing and modifying a part of a coded document, for example a structured document of Binary XML type, as well as associated devices.

In particular, the accessing method comprises the decoding of the part to access using a decoding table (300′, 310′) having entries each of which associating a non-coded item (220) with a coded field (225).

The method is particular in comprising a step (430, 530) of forming said table for the decoding from:
at least one initial coding/decoding table (300, 310) grouping together entries corresponding to a plurality of coded fields of the document and comprising, for at least one entry, an indication of the first occurrence (320, 330), within the coded document, of the item associated with the entry; and
a determined location (L), within the coded document, of a first coded field of said part to access.

This application claims priority from French patent applications No. 08 52827 of Apr. 25, 2007 and No 09 50862 of Feb. 11, 2009, which are incorporated herein by reference.

### FIELD OF THE INVENTION

The present invention concerns a method and a system for accessing a part of a coded document, as well as a method and a system for modifying a part of a coded document, for example a structured document of Binary XML type (XML being an acronym for “eXtensible Markup Language”).

### BACKGROUND OF THE INVENTION

The XML format is a syntax for defining computer languages, which makes it possible to create languages adapted to different uses which may however be processed by the same tools.

An XML document is composed of elements, each element starting with an opening tag comprising the name of the element (for example: <tag>) and ending with a closing tag which also comprises the name of the element (for example </tag>). Each element can contain other elements or text data.

An element may also be specified by attributes, each attribute being defined by a name and having a value. The attributes are then placed in the opening tag of the element they specify (for example <tag attribute=“value”>).

XML syntax also makes it possible to define comments (for example: “<—Comment—>”) and processing instructions, which may specify to a computer application what processing operations to apply to the XML document (for example: “<?myprocessing?>”).

In XML terminology, the set of the terms “element”, “attribute”, “text data”, “comment”, “processing instruction” and “escape section” are grouped together under the generic name of “item”. In a more general context, all these terms (forming for example the element defined between an opening tag and a closing tag) may be grouped together under the generic name of “node”.

Several different languages based on XML may contain elements of the same name. To be able to mix several different languages, an addition has been made to XML syntax making it possible to define “Namespaces”. Two elements are identical only if they have the same name and are situated in the same namespace. A namespace is defined by a URI (acronym for “Uniform Resource Identifier”), for example “http://canon.crf.fr/xml/mylanguage”. The use of a namespace in an XML document is via the definition of a prefix which is a shortcut to the URI of that namespace. This prefix is defined using a specific attribute (for example “xmlns:ml=“http://canon.crf.fr/xml/mylanguagea” associates the prefix “ml” with the URI “http://canon.crf.fr/xml/mylanguage”). Next, the namespace of an element or of an attribute is specified by preceding its name with the prefix associated with the namespace followed by “:” (for example “<ml:tag ml:attribute=“value”>” indicates that the element tag arises from the namespace ml and that the same applies for the attribute attribute).

To process an XML document, it must be read from memory. Two families of reading methods exist for an XML document.

The first family of methods consists of representing the entirety of the XML document in memory, in tree form. These methods enable easy access to any part of the XML document but require a large memory space. An example of these methods is the DOM (“Document Object Model”) programming interface.

A method is known of accessing a part of a non-coded XML document that relies in part on this reading method, in particular the VTD-XML project (http://vtd-xml.sourceforge.net/technical/0.html). According to the latter, the XML document is pre-processed and a tree representing it is constructed in memory. This tree is a partial representation of the XML document, in which only the structure of the XML document is contained in memory. The content of the XML document is not duplicated in memory and is accessible from the structure using pointers placed in the nodes of the latter.

This method has the advantage of making it possible to rapidly access any node of the XML document, since the navigation to the node that is sought is made on the basis of the tree contained in memory, without however requiring a large amount of memory, since the content of the nodes of the XML document is not stored in memory.

A second family of methods consists of representing each node of the XML document by one or more events. The entirety of the XML document is then described by the succession of those events. These methods make it possible to process an XML document progressively as it is read (“streaming” mode).

An advantage of these methods lies in the small amount of memory required for their processing. Nevertheless, they impose navigation in the document solely in the order of reading thereof. Examples of these methods are the programming interfaces SAX (“Simple API for XML”) and StAX (“Streaming API for XML”).

The XML format has numerous advantages and has become a standard for storing data in a file or for exchanging data. First of all, the XML format makes it possible in particular to have numerous tools for processing the files generated. Furthermore, an XML document may be manually edited with a simple text editor. Moreover, as an XML document contains its structure integrated with the data, such a document is very readable even without knowing the specification.

However, the main drawback of the XML syntax is to be very prolix. Thus the size of an XML document may be several times greater than the inherent size of the data. This large size of XML documents thus leads to a long processing time when XML documents are generated and especially when they are read.

To mitigate these drawbacks, mechanisms have been put in place of which the object is to code the content of the XML document in a more efficient form, enabling the XML document to be easily reconstructed. However, most of these mechanisms do not maintain all the advantages of the XML format. There are nevertheless new formats which enable the data contained in an XML document to be stored. These different formats are grouped together under the appellation “Binary XML”.

Among these mechanisms, the simplest consists of coding the structural data in a binary format instead of using a text format. Furthermore, the redundancy of the structural information in the XML format may be eliminated or at least reduced (for example, it is not necessarily useful to specify the name of the element in the opening tag and the closing tag). This type of mechanism is used by all the Binary XML formats.

Another mechanism consists of using one or more index tables, in particular for the names of elements and attributes which are generally repeated in an XML document. Thus, at the first occurrence of an element name, it is coded normally in the file and an index is associated with it. Then, for the following occurrences of that element name, the index is used instead of the complete string, reducing the size of the document generated, while also facilitating the reading. More particularly, it is no longer necessary to read the entire string in the file, and, furthermore, determining the element read may be performed by a comparison of integers instead of a comparison of strings. This type of mechanism is used by formats such as Fast Infoset or Efficient XML Interchange (EXI) (tradenames).

Fast Infoset is an ITU-T and ISO format making it possible to code an XML document in a binary form. This format uses in particular binary indicators to describe the different nodes contained in the XML document, as well as index tables for the names of elements, the names of attributes, the values of attributes and the text values.

EXI is a format in course of being standardized by the W3C (acronym for “World Wide Web Consortium”, an organization producing standards for the Web) which enables an XML document to be coded in a binary form. It adopts similar mechanisms to those of Fast Infoset. However, it adds a mechanism of dynamic grammars describing the structure of the elements. For each element having a given name, a grammar describes the content of the elements bearing that name. This grammar evolves according to the content encountered for the elements bearing that name at the time of the coding or decoding. These grammars may be considered as a form of indexing for the nodes contained in an element.

Thus, for example, it is possible to use a grammar for each element node having a given name. At the first occurrence of a child node in the content of that node, a new entry describing that child node type is added to the grammar with an associated index. At following occurrences of a similar child node, that new child node is described using the associated index.

These grammars and other index tables are created progressively during the course of the coding of the XML document into a Binary XML document, as well as progressively during the course of the decoding of the Binary XML document. These tables are thus called coding and/or decoding tables.

By way of illustration, the EXI format provides the following coding or decoding tables:

URI tables,
tables of prefixes associated with a URI. There is one table of prefixes per URI;
tables of associated local names each of which is associated with a URI. There is one table of local names per URI;
local tables of values for text content and attributes; there is a local table of values for each element and for each attribute, and a global table of values grouping together the values of all those local tables;
grammars or tables of structures making it possible to describe the structure of the content of an element. There are several structure tables for each element.

The use of Binary XML formats makes it possible to obtain documents that are more compact and also enables faster processing (reading or writing) of those documents. However, the use of Binary XML formats has drawbacks.

In particular, a drawback of this format has been illustrated with reference to FIGS. 1 and 2. FIG. 1 represents an XML document example listing persons, the list containing the last names (in the elements named “lastname”) and first names (in the elements named “firstname”) of two persons, “Mary Smith” and “John Smith”. It is to be noted that for reasons of presentation, the content of this document is presented with indentation over several lines, but the spaces present in the drawing should be ignored for the processing operations described in the following portion of the text.

The two persons described in this document have the same family name (“lastname”): “Smith”. If a mechanism is used for Indexing the values, the first occurrence of “Smith” is coded just as it is, as a string with which an index is associated. However, the second occurrence of “Smith” is coding using that index solely. This mechanism is similar on decoding: at the occurrence of the value “Smith” in the document to decode, this value is associated with the index used for the coding. Thus, any later occurrence of this index in the document to decode indicates that the value contained in the document at that location is “Smith”.

This coding by index according to the EXI format is illustrated by FIG. 2 which shows examples of tables created to code or decode the XML document of FIG. 1 in a Binary XML format. These two tables rely on the principle of substitution, on coding, of a part of the XML document by an index. Whatever the coding process of a document or that of the decoding of the same coded document, the coding and decoding tables are identical. In the following portion of the description, the terms “coding” and “decoding” for the tables solely qualify the more general process in which they are used.

Table 200 is an index table for the text values contained in the XML document, This index table is created at the time of coding or decoding the XML document. Each time a new text value 220 is encountered, that value is added to the end of the table and the first index value 225 not used is associated with it. On coding, this new value is coded in the Binary XML document. On decoding, this new value is decoded on the basis of the Binary XML document.

When the same text value is again encountered in a document (for example in the case of “Smith” at line 175 of the document of FIG. 1), that text value 220 is replaced by its index 225. In the case of the coding, the index value 225 is used as a coding value (possibly itself coded) in the Binary XML document (and not the text value 220), the value of the index being obtained from the table 200. In the case of the decoding, the value of the index is decoded from the Binary XML document, then the text value is obtained from the table 200.

Thus, on coding, the table 200 makes it possible to obtain an index 225 from a text value 220. On decoding, the table 200 makes it possible to obtain a text value from an index.

The table 200 shows the state of the index table for the text values at the end of the coding or the decoding of the document of FIG. 1.

Table 210 is a grammar (or index table) for the content of the “person” element of the document of FIG. 1. This grammar is created at the time of coding or decoding the XML document. Each time a new type of content 230 is encountered for a “person” element, a new entry (also called production) is added to the start of that grammar. Thus, the entry 211 corresponding to the start of a “lastname” element 230 has been added after the entry 212 corresponding to the start of a “firstname” element. The other entries 213, 214 and 215 are present by default in the grammar. Each entry describes a type for the content encountered (or which could be encountered in the case of the entries present by default) and an index 235 is associated therewith. The operation of this table 210 is similar to that for the table 200, It is to be noted that in the description, the values of index for the table 210 are recalculated each time a new entry is added to that table.

The table 210 shows the state of the grammar of the “person” element at the end of the coding or the decoding of the document of FIG. 1.

In this table, the code “SE” corresponds to the start element event. This code is followed between brackets by the element name or by “*” to represent any particular element (of which the name will be coded in the Binary XML document. The code “EE” corresponds to the element end event and the code “CH” corresponds to a text node.

It is to be noted that FIG. 2 only presents two tables, but in practice, other coding or decoding tables may be used as listed previously by way of illustration. These other coding or decoding tables will generally have similar structures to those of the tables 200 or 210. For example, in the case of the document of FIG. 1, coding tables corresponding to the content of the “firstname” and “lastname” elements are used. These tables have similar structures to the table 210.

Returning to FIG. 1, if it is desired to directly access the family name of the second person in the coded Binary XML document, it is necessary to have read beforehand the family name of the first person in order to know the string associated with the index used to code the family name of the second person.

Thus, to access the desired part of the document and thus to decode it, it is necessary to decode the whole of the start of the document in order to have available the decoding information used for that part. Binary XML formats thus make it difficult to directly access an information item situated in the middle of the document without decoding everything that precedes that information item. The decoding of the start of the document furthermore represents a high processing cost, in particular when various parts of the document are regularly accessed.

The invention aims to solve these drawbacks of the state of the art.

### SUMMARY OF THE INVENTION

To that end, the invention in particular concerns a method of accessing part of a document on the basis of a coded version of said document, the method comprising the decoding of the part to access using at least one decoding table having entries, each of which associating a non-coded item with a coded field, and the method comprises a step of forming said at least one table on the basis of:
at least one initial coding/decoding table grouping together the entries corresponding to a plurality of coded fields of the document and comprising, for at least one entry, an indication of the first occurrence, within the coded document, of the item associated with the entry; and
a location, within the coded document, of a first coded field of said part to access.

The first occurrence of an item corresponds to the first appearance of the item considered in the document. Correspondingly, the first coded field of a part to access is that which has a location in the document which is the closest to the start thereof.

The initial table generally corresponds to the coding table (for example the tables 200, 210 of FIG. 2) obtained at the end of the coding of the complete document. All the associated coded fields and items that are present in the coded document are then in this table.

Thus, using this indication of first occurrence, the invention makes it possible to easily retrieve, from the complete or initial tables referencing all the entries resulting from the coding of the document, the state of the tables used for the coding and/or the decoding at the desired point of access to the document even though no decoding has been carried out.

The invention is all the more efficient in that the construction of the coding/decoding tables is carried out independently of the access to the document. Thus, at each later access to the document, these initial tables enable rapid retrieval of the state at the point of access to the document.

By virtue of the invention, it is no longer necessary to decode, and possibly recode, the part of the document preceding the point of access at each access to the document.

The invention applies to structured electronic documents, in particular markup documents coded in Binary, for example Binary XML documents such as in the Fast Infoset or EXI format.

In particular, the forming step comprises:
determining said location, within the coded document, of the first coded field of said part to access; and
selecting the entries of the at least one initial table of which the first indicated occurrence is located, within the coded document, before said determined location, so as to form said at least one coding/decoding table;

said decoding of said part to access being, furthermore, carried out using the selected entries.

It may be understood that a document has a first element and a last element respectively defining the start and end of the document. For the following portion of the description. Any concept of order is understood relative to the conventional path of documents from their start element to their end element. Thus the first coded field of the part to access is the coded field of said part which is closest to the start of the document considered.

The entries selected according to the invention thus form the decoding tables that are appropriate for directly decoding the part to access. It may happen that no entry is selected and that the decoding tables formed are empty. This is in particular the case when the very start of the coded document is accessed.

Initially, access is made to the first coded field of the part to access, then the coding/decoding tables formed with the selected entries evolve conventionally, progressively with the decoding of the other fields of the part to access.

This selection may be performed by simple marking, for example via a binary flag, of the entries selected within the initial table, it only being possible for the later evolution to consist of the evolution of the marking of the unmarked entries.

However, an embodiment will be preferred in which said selection comprises the deletion, from said at least one initial table, of the entries of which the first indicated occurrence has a location subsequent or equal to said determined location so as to form said at least one table for the decoding. A table is thus retrieved that in every respect conforms to that normally manipulated at the place of access.

In particular, the method may comprise a step of duplicating said at least one initial coding/decoding table before said selecting step. Thus, the complete/initial tables are kept intact, which it will be possible to use, by new duplications, for the later accesses to the document.

According to a particular feature of the invention, the entries of the at least one initial table comprise a reference for the location, in said coded document, of the definition of the associated coded field. In this configuration, the coding definition information is not directly stored in the entries of the initial tables, but by reference to the location of their definition in the coded stream. This enables the size of these initial tables to be reduced for easier transmission.

In particular, said at least one initial table is transmitted attached to the coded document, either integrated directly into the coded document, or in a file attached to it. The access to a part of a coded document according to the invention may thus be carded out efficiently on a site that is remote from that generating the document.

Particularly, said reference points to said first occurrence. Thus, in a brief item of information, typically a pointer, the entry of the initial table is fully defined, including, implicitly, the indication of the first occurrence used in the implementation of the invention.

According to a particular feature of the invention, the forming step comprises:
selecting at least one entry from the initial table of which the first indicated occurrence is located, within the coded document, before said location of a first coded field;
accessing at the location referenced in said selected entry and decoding the coded data at said location to form an entry of the decoding table.

These steps make it possible to constitute the entries of the decoding table by retrieving, directly from the coded stream, information for defining the entries; the item or the value concerned. The coding value associated with the entry (the index) is determined by the position of the entry in the table and the current number of entries in the table.

In particular, the method comprises a step of obtaining an item of coded data from said part to decode, and the steps of selecting, accessing and decoding the entry associated with that item of coded data are carried out further to said obtaining if no entry associated with said item of coded data is present in said decoding table.

Here, the decoding table or tables are constructed in parallel with the actual decoding of the document. According to these specific provisions, the entries of the decoding table are created solely when they are utilized in the part of the document to access. Creating entries that are of no use for that access is thus avoided and the processing according to the invention is accelerated.

Particularly, prior to the decoding of the part to access, the method comprises a step of counting the number of entries of said initial table of which the first associated occurrence precedes said location of the first coded field of the part to access. This counting step enables the number of entries of said initial table to be known and thus enables the coding value associated with each entry (its index) to be known. This is because the index of an entry of the table is coded on the basis of the current number of entries of the table, to use an optimal coding size.

In one embodiment, said indication of first occurrence comprises a location indication of pointer type pointing to the position of the first occurrence of said coded field within the coded document. The location of the occurrence is thus rapidly obtained without additional processing. In the case where the entries reference their definitions in the coded document, this pointer has a double function: first occurrence indicator and reference to the definition of the entry. As a matter of fact, it proves to be the case that, generally, the information defining the use of an index for the coding of an item is coded, in the document, at the first occurrence of the coded item.

As stated above, an increased efficiency is sought by the invention by constructing the initial coding/decoding tables independently of the access to the document.

Thus, it is first of all envisaged that the method comprises a step of constructing the at least one initial coding/decoding table, said construction being prior to the direct access to said coded document. For example, said construction is carried out at the same time as the coding of said document in its coded version. The time for producing those tables is thus optimized. This implementation is envisaged in particular when it is the same device which codes the initial document and which accesses it later. However, this initial table could be attached to the coded document, the group thereof being transmitted later.

As a variant, said coded document is received by an access device, said construction being carried out by said access device at the time of an earlier access to said coded document. It is noted that an increased efficiency is obtained when that construction is carried out at the time of the first direct access to the document, since it will be possible for all the later accesses to benefit from that prior construction.

In one embodiment, said at least one initial table is stored in memory of an access device, said storage depending on at least one priority information item associated with said document. This storage is associated with the later use of these tables at the time of future accesses.

In particular, said priority information is chosen from among the set comprising an information item on frequency of use of said document, an information item on average location of the accesses made to said document, and the size of said document. However, a combination of these different items of information is also envisaged.

Moreover, by considering the solutions of the prior art, it also appears difficult to update an item of data within the Binary XML document.

While in a document in XML format, it suffices to modify that item of data directly within the document, in the case of a Binary XML coded format, this is no longer possible. More particularly, the coding of the initial item of data may take several forms: direct coding or via an index. Similarly, the coding of the modified item of data may also take several forms which depend on what comes earlier in the document. Furthermore, the modifying of the item of data may affect the coding of what follows in the document.

This problem context is illustrated with reference to FIG. 1. If it is desired to update the family name of the first person, to replace “Smith” with “Thompson”, it is necessary, on use of a mechanism for indexing the values for the coding, to recode not only the first occurrence of “Smith” (the one actually modified), but also the second (this one not being modified but its coding depended on the first occurrence).

It thus appears that modifying an item of data in an XML document stored in a Binary XML format cannot be carried out simply, leading to heavy and costly decoding operations for the whole document in memory to carry out the desired modifications therein prior to recoding.

With that aim, the invention also concerns a method of modifying part of a document on the basis of a coded version of said document, comprising:
a step of accessing said part to access for modification, according to the access method already set out; and
said decoding of the part to access, thus as from the determined location (i.e. generally the start of the part to modify), being followed by a modification of said decoded part and coding of said modified part into a modified coded document.

By virtue of the efficient access directly to the desired part, a modification to the document can be carried out without interacting, through coding or decoding, with the start of the coded document, corresponding to the portion before said part to modify.

In particular, it is provided that the method comprises determining the location, within the coded document, of the first coded field of said part to access, then selecting the entries and decoding said part to access as referred to above. Thus, since the desired position for modification is accessed directly, a step is provided of copying the start of the coded document up to said determined location. This copying step is carried out to a coded and modified version of the initial document.

This step of copying or direct placing at the first coded field of the part to modify contributes to the performance of the invention, compared with the known solutions which require the decoding of the start of the document then its recoding.

In one embodiment, the method comprises a step of determining the location, within the coded document, of the last coded field to modify:
said decoding of the part to modify being continued up to said location of the last coded field to modify.

It is noted that this last coded field to modify is not necessarily in the part to modify defined initially. This is because it may be that the coding of this field identified as the last must be modified due to the modifications made upstream in the document (for example by shifting of the coding indices).

This location of the last coded field to modify makes it possible, in combination with the location of the first coded field, to efficiently delimit the extent of the parts of the document to modify. This delimitation makes it possible to avoid unnecessary decoding/recoding operations of the parts not affected by the desired modification.

In the absence of location of the last coded field to modify, the coded (then modified) document is coded, modified and recoded all the way to its end.

By virtue of the location of the last coded field to modify, it is possible, further to the decoding, to the modification and to the coding of the part so modified, to make provision for copying the end of the coded document as from said location of the last coded field to modify.

This step constitutes a further step of notable improvement in processing operations relative to the known techniques, since the end of the coded document does not need decoding and recoding when the part to modify can be efficiently delimited.

In one embodiment, at least one entry of said at least one initial coding/decoding table comprises an indication of the last occurrence, within the coded document, of the item associated with the entry.

It is noted at this stage that this indication may be of the same nature as that for first occurrence: location information and/or pointer. This information is useful, as will be seen later in the detailed description, to determine, among other things, with the greatest possible precision, the location of the last coded field that is affected by the desired modification (the last coded field to modify).

Furthermore, it enables easy establishment of a refined table by only including therein the entries which only concern items of which all the occurrences (i.e. first and last occurrences) precede the start of the part to access. Thus, for such entries, only their existence is indicated in the refined decoding table (in order to be able to correctly calculate the total number of entries in the table and the index corresponding to each entry actually used), but their content is not given.

In particular, in the case in which the construction of the at least one initial coding/decoding table is carried out, it is provided for this construction to comprise:
a preliminary step of modifying at least one basic coding/decoding table, for example obtained during the prior coding of said document in its coded version, by the addition, for each entry, of an indication of first occurrence taking the value of the document start location and of an indication of last occurrence taking the value of the document start location; and
a later step of processing at least one item of said document, comprising modifying the indication of last occurrence of the entry corresponding to said item, on the basis of the location, within the coded document, of the coded field corresponding to said processed item.

This implementation makes it possible to obtain, via simple mechanisms, the coding tables with reference of the occurrences by a single processing operation of the document, for example during the initial coding of the document or during a first decoding of the coded document.

In particular, it may happen that no entry associated with said processed item exists in said table. It is then provided that the later step comprises creating an entry associated with said processed item, said entry comprising indications of first and last occurrences giving the location, within the coded document, of the coded field corresponding to said processed item.

In this case, this later step is in particular carried out during the recoding of the modified part in order to keep up to date said initial tables for the later accesses and modifications.

In order to possess new initial tables updated for the whole of the coded document, the table entries should be processed which correspond to the items later than the part to modify of the document. With that aim, it is provided for the method to comprise, further to the step of coding said modified part, retrieving, either by copying from the initial table obtained after construction when the entries have been deleted, or by demarcation of the selected entries, in the at least one table comprising said selected entries (used for the decoding or the coding and updating operations since), the entries of the at least one constructed initial coding/decoding table of which the first occurrence is located, within the coded document, at or after said location of the last coded field to modify.

and if the difference between that last location and the location, within the coded modified document, of the last coded field of the modified part is not zero, modification is carried out, for the entries retrieved, of the location indications (equally well for the first as for the last occurrence), subsequent or equal to said location of the last coded field to modify, by a value equal to said difference, through increment or decrement according to the sign of the difference.

This processing makes it possible to retrieve all the entries of the table corresponding to the end of the coded document and which are not affected by the modification made to the document. They should thus be retrieved and their respective locations be updated in order to take into account a possible shift introduced by the lengthening or shortening of the modified part.

At the end of the processing operation, modified initial coding tables are thus obtained corresponding to the coded document after its update. These are therefore tables that are available for the later accesses or modifications of that document.

In one embodiment, said selection of the entries comprises deleting, from said at least one initial table, the entries of which the first indicated occurrence has a location subsequent to said determined location so as to form said at least one table for the decoding or coding, the method comprising duplicating the at least one table so obtained so as to possess at least one decoding table, used for said decoding of the part to modify, and at least one coding table, used for the coding of said modified part. Thus in a single action, both tables are obtained which will successively make it possible to decode then recode the part to modify/modified.

In particular, said coding table is optimized for determining a field coded on the basis of a non-coded item and said decoding table is optimized for determining a non-coded item on the basis of a coded field.

In one embodiment of the invention, said at least one initial table is stored in memory of an access device, said storage depending on the at least one priority information item associated with said document, said priority information item being one chosen from the set comprising an information item on frequency of use of said document, an information item on average location of the accesses made in said document, an estimation of the time for decoding the coded document and coding the modified document, a measurement of the average time for modifying the coded document, and the size of said document.

The invention also concerns a method of modifying a plurality of parts of a document on the basis of a coded version of said document, comprising:
determining, for each of said parts to access for modification, the location, within the coded document, of the first coded field of said part to access,
selecting the closest location to the start of said coded document, from among said locations determined for the parts to modify;
selecting the entries of at least one initial table of which the first indicated occurrence is located, within the coded document, before said selected closest location, said at least one initial coding/decoding table comprising entries each associating a non-coded item with a coded field and at least one entry comprising an indication of the first occurrence, within the coded document, of the item associated with said entry.
decoding the parts to modify using the selected entries, followed by modifying the decoded parts and coding the modified parts.

Optionally, the method of modifying a plurality of parts may comprise steps of the modification method set forth above.

The invention also concerns a device for accessing or modifying part of a document on the basis of a coded version of said document, comprising means for decoding said part to access using at least one coding/decoding table having entries, each of which associating a non-coded item with a coded field, and means for forming said at least one table from:
at least one initial coding/decoding table grouping together the entries corresponding to a plurality of coded fields of the document and comprising, for at least one entry, an indication of the first occurrence, within the coded document, of the item associated with the entry; and
a location, within the coded document, of a first coded field of said part to access.

In one embodiment, said forming means comprise:
means for determining the location, within the coded document, of the first coded field of said part to access;
means for selecting the entries of the at least one initial table of which the first indicated occurrence is located, within the coded document, before said determined location, so as to form said at least one coding/decoding table for the decoding; and

the decoding means being adapted to decode said part to access using the selected entries.

In particular, the device comprises means for determining the location, within the coded document, of the last coded field to modify,
in which device the decoding means are adapted to decode said coded document up to said location of said last coded field to modify,
the device comprising means for modifying said decoded part and means for coding said part so modified into a coded modified document.

Provision is also made for the device to comprise means for copying, to the coded modified document, the start of said coded document to modify up to said location of the first coded field and the end of said coded document to modify as from said location of the last coded field to modify.

In one embodiment, said device comprises means for storing a plurality of initial coding/decoding tables associated with a plurality of coded documents, said device being adapted to manage the storage of said initial tables on the basis of at least one priority information item associated with each coded document.

In particular, the storage means comprise a plurality of memories, said device being adapted to distribute said initial tables in the plurality of memories on the basis of said priority information items. It is thus possible to optimize the use of the memory resources as well as the speed of access to certain tables (for the most used documents for example) rather than others.

Optionally, the device may comprise means relating to the features of the accessing and modifying methods set forth above.

The invention also concerns a data structure associated with a document coded using at least one coding table having entries, each of which associating a non-coded item with a coded field, the data structure comprising, for entries of the at least one coding table (resulting from the coding of said document), a reference for the location, in said coded document, of the definition of each entry, and an indication of first occurrence of the item associated with the entry. It is noted here that this data structure is none other than the initial tables referred to previously.

In particular, said reference and said indication are conjointly made by means of the same pointer to said first occurrence.

In detail, said structure comprises, for each of the coding tables, a field indicating the number of entries of said table.

The invention is particularly well-adapted to the EXI format. In this case, said structure comprises a first section conjointly coding a table of namespaces, tables of prefixes associated with the namespaces and tables of local names associated with the namespaces. This conjoint coding enables optimization of the size of structure (and thus of the initial table) to attach to the coded document.

In particular, the first section comprises the number of entries of the table of namespaces followed, for each of the namespaces, by a pointer to the definition of the corresponding namespace in the coded document, by the number of entries of the table of prefixes associated with the namespace, by the number of entries of the table of local names associated with the namespace and by pointers to the definition of each of the entries of the two tables of prefixes and local names.

Said structure also comprises a second section conjointly coding tables of values and tables of structures (grammars) that are attached to the same item, also called qualified name.

A qualified name is generally defined by two items of information: a namespace (defined by its URI for example) and a name in that space identifying the item.

In particular, this second section comprises the number of qualified names followed by information relative to each of those qualified names, this information comprising:
a description of said qualified name,
a first sub-section describing a table of values associated with said qualified name,
a second sub-section describing one or several tables of structures associated with said qualified name.

In particular, the qualified names are sorted within said second section. This provision enables a more efficient dichotomous search within the section, when it is desired to access specific data of a qualified name.

According to one feature, the qualified names are grouped together, in said second section, according to the nature of the corresponding item, for example the qualified names of attributes on one side, and the qualified names of elements elsewhere.

An information storage means, possibly totally or partially removable, that is readable by a computer system, comprises instructions for a computer program adapted to implement the accessing or modifying method in accordance with the invention when that program is loaded and executed by the computer system.

A computer program readable by a microprocessor comprises portions of software code adapted to implement the accessing or modifying method in accordance with the invention, when it is loaded and executed by the microprocessor.

The means for computer program and information storage have characteristics and advantages that are analogous to the methods they implement.

### BRIEF DESCRIPTION OF THE DRAWINGS

Still other particularities and advantages of the invention will appear in the following description, illustrated by the accompanying drawings, in which:

FIG. 1 represents an XML document example;

FIG. 2 represents examples of tables created, in conventional manner, to code or decode the XML document of FIG. 1 in a Binary XML format;

FIG. 3 represents examples of tables created to access or modify the document of FIG. 1 in accordance with the invention;

FIG. 4 represents, in flow diagram form, an example of steps of accessing a part of a document according to the invention;

FIG. 5 represents, in flow diagram form, an example of steps of modifying a part of a document according to the invention;

FIGS. 6 and 7 represent, in flow diagram form, steps of generating modified coding tables implemented in the method of FIGS. 4 and 5;

FIG. 8 represents, in flow diagram form, steps of generating coding tables for a precise location of the document processed during the processes of FIGS. 4 and 5;

FIG. 9 illustrates the evolution of a coding table on use by the present invention;

FIG. 10 represents, in flow diagram form, steps for determining a final location of modification of the document processed during the processes of FIG. 5;

FIG. 11 illustrates, in flow diagram form, steps of modifying the document during the process of FIG. 5;

FIG. 12 shows a particular hardware configuration of a device adapted for an implementation of the method according to the invention;

FIGS. 13 and 14 represent two sections of a data structure representing tables for access in accordance with the present invention;

FIG. 15 represents, in the form of a flowchart, an example of steps for generating coding/decoding tables modified on the basis of the structure of FIGS. 13 and 14; and

FIG. 16 represents, in the form of a flowchart, another example of steps for generating decoding tables modified on the basis of the structure of FIGS. 13 and 14.

### DETAILED DESCRIPTION OF EMBODIMENTS OF THE INVENTION

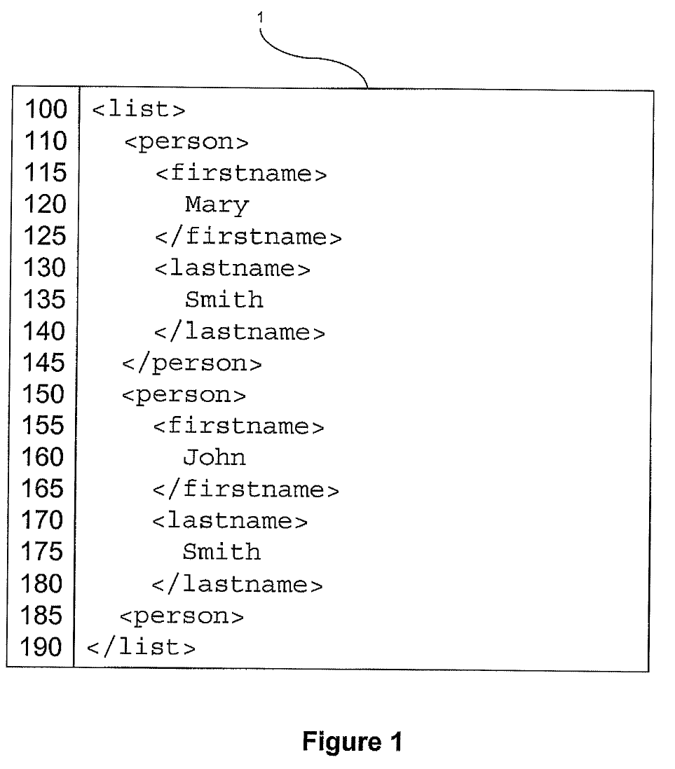

The invention is now described and illustrated using the example of modifying the family name of the first person in FIG. 1, in this case “Smith” at line 135, to replace it by another name, “Thompson”.

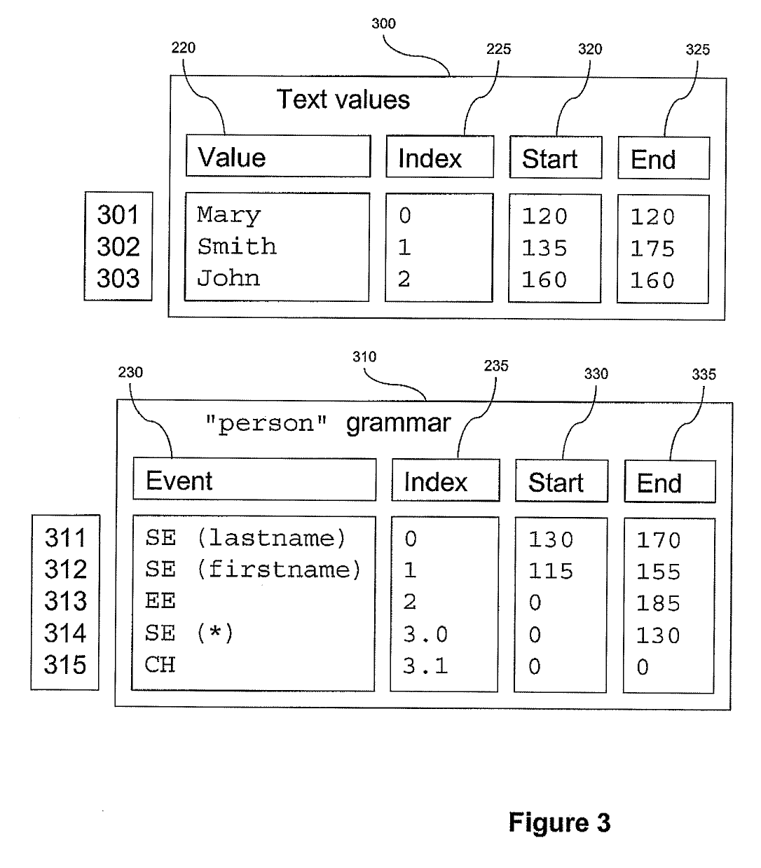

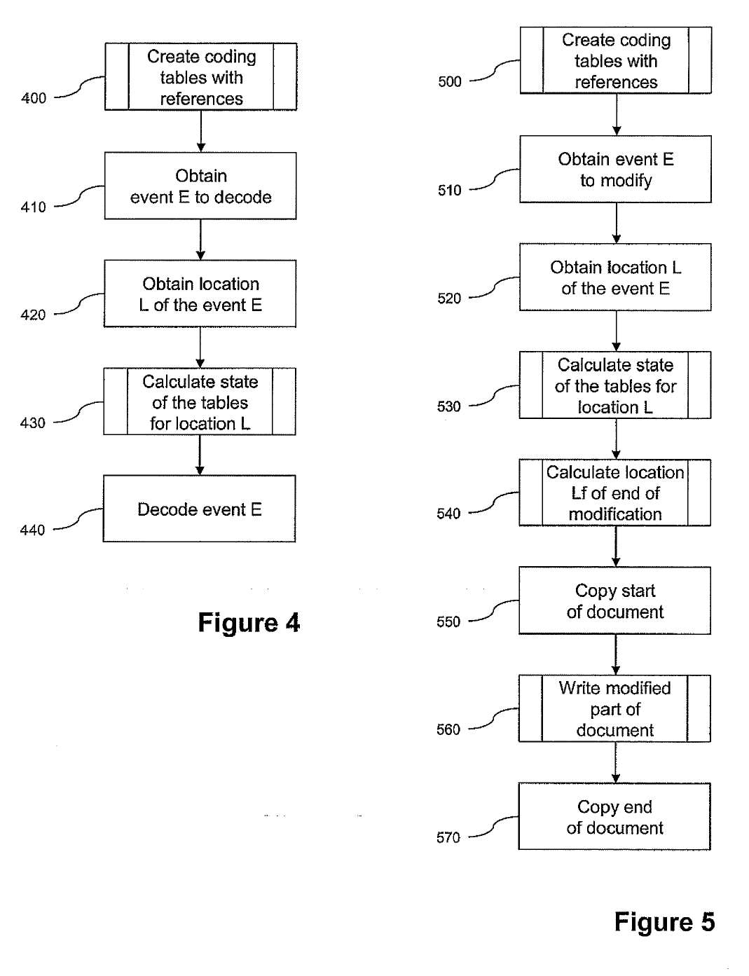

FIG. 3 illustrates the coding or decoding tables used for the implementation of the invention. The constitution and the evolution of these tables are described in more detail with reference to FIGS. 4 to 11.

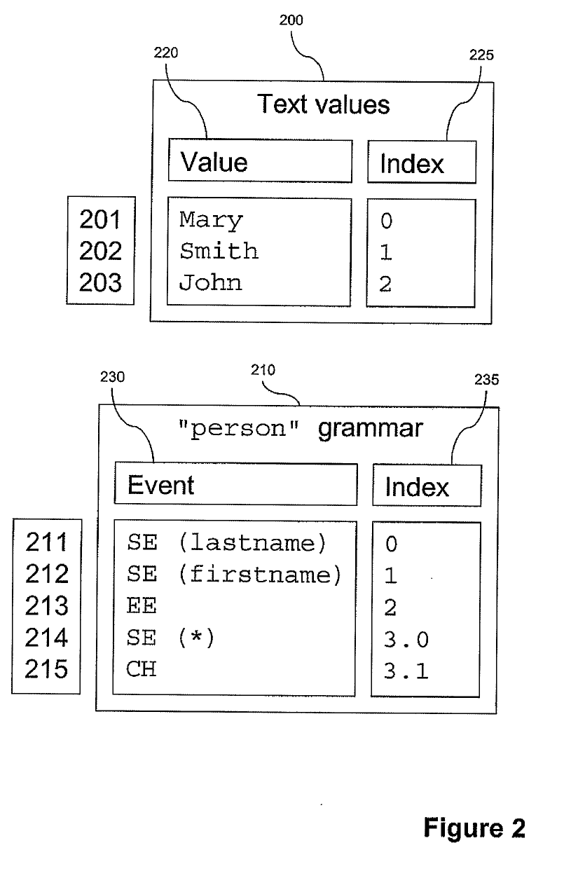

FIG. 3 shows the two tables of FIG. 2 as modified by the invention.

Table 300 is the index table for the text values contained in the document 1. It repeats the information contained in table 200 and adds additional information thereto.

This additional information is contained in columns 320 and 325:
in column 320, for each entry in the table, is indicated the fine of the event of document 1 which is at the source of that entry, that is to say the first occurrence of the event in document 1;
in column 325, for each entry in the table, is indicated the line of the last event (or last occurrence) in document 1 using that entry.

Thus, for example, for the entry 3011 which corresponds to the text value 220 “Mary”, the line of the first event is line 120, which corresponds to the first occurrence of that text value in document 1. For this same entry, the line of the last event is also line 120, since that text value only appears once in the document.

On the other hand, for the entry 302, which corresponds to the text value 220 “Smith”, the line of the first event is line 135, whereas the line of the last event is line 175.

Table 310 is the grammar for the content of the element “person”. In a similar way to table 300, table 310 repeats the information contained in table 210 and adds thereto additional information in columns 330 and 335;
in column 330, for each entry in the table, is indicated the line of the event of document 1 which is at the source of that entry.
in column 335, for each entry in the table, is indicated the line of the last event in document 1 using that entry.

Thus, for example, for the entry 312, which corresponds to the start of the element 220 “firstname” within the element “person”, the line of the first event is line 115, and the line of the last event is line 155.

It is to be noted that the entries 313, 314 and 315 have 0 as starting line, since these entries are created prior to the coding and decoding of the document. Furthermore, as line 315 is not used during the coding or the decoding of the document, its end line is also 0.

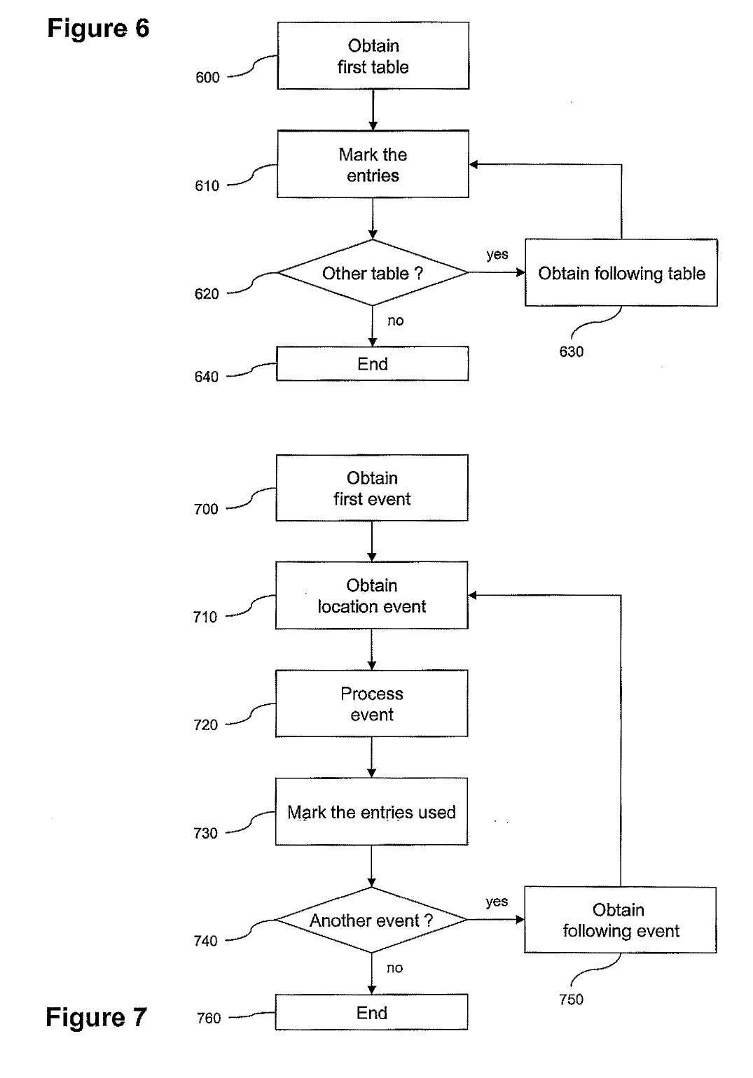

The passage of tables 200, 201 to tables 300, 301, including the filling of the columns for first and last occurrences is described in more detail below with reference to FIGS. 6 and 7.

The columns for start of use (320 and 330) and for end of use (325 and 335) make it possible to determine which part of the XML document an entry concerns. The start of use column makes it possible to determine which event is responsible for creating the entry, whereas the end of use column makes it possible to determine what is the range of the entry, that is to say the extent of the document portion encompassing all the uses made of that entry. This information is used by the invention to efficiently modify the XML document, as illustrated below with reference to FIG. 5. As for the item of information on start of use (320 and 330), this alone enables efficient access to an event in the document, as detailed below with reference to FIG. 4.

More generally, the start of use column contains, for each entry of the table, an indication of the first event using that entry, that is to say an indication of the event at the source of the creation of that entry. In binary formats, it is in particular at the location of that first occurrence in the coded file that the definition of that entry is to be found. This definition is used by the decoder to constitute its decoding tables.

The end of use column contains, for each entry of the table, an indication of the last event using that entry.

In practice, these indications may be a pointer to the position of the corresponding event within the Binary XML document, or an item of information on position of that event within the Binary XML document. An efficient way to code this information consists of indicating the position of the event relative to the start of the file containing the Binary XML document.

As was stated with reference to FIG. 2, other coding tables may be used for the coding of an XML document. In this case, the invention is also applied to these other coding tables.

A description is now given of the different steps for direct access to a part of a Binary XML document 1, with reference to FIG. 4.

The first step (400) consists of creating coding (or decoding) tables 300, 310 containing start of use information (320, 330) for each of their entries. The creation of the coding tables is described with reference to FIGS. 6 and 7. It is noted that the coding/decoding tables coming from this step list all the information used for the coding (or the decoding) of the Binary XML document 1.

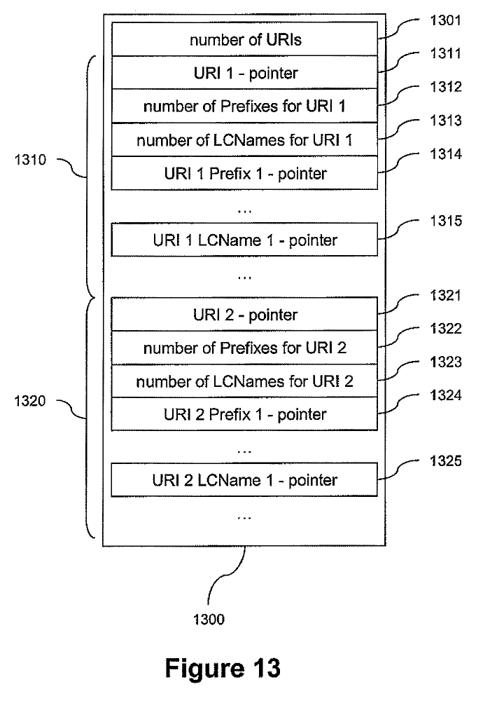

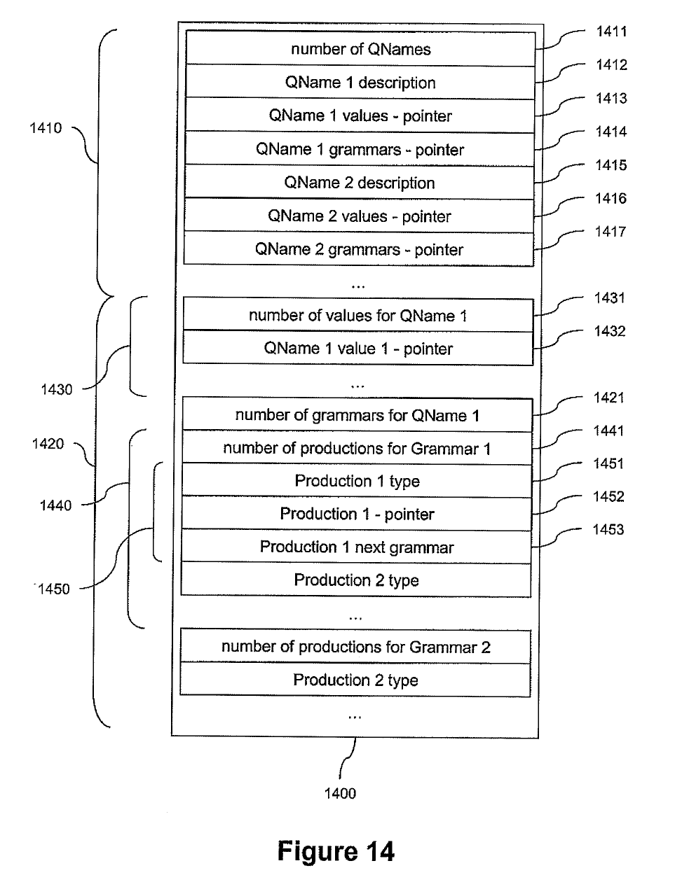

Another example of coding/decoding tables 300, 310 is illustrated in FIGS. 13 and 14.

This step is carried out prior to the direct access to the XML document. It may be performed at several times according to the scenario of use of the invention. The present invention is all the more efficient in that these coding/decoding tables 300, 310 are available to the processing device on later accesses to the document 1 to which those tables corresponds Provision is thus made to save those tables in memory or to transmit them with the coded document which it is wished to partially access.

In a first case of use of the invention, the Binary XML document is generated by the device which will then access it. In this case, on generation of the document 1, the coding tables 300, 310 according to the invention are created and stored in memory.

In a second case of use of the invention, the Binary XML document 1 is received by the device which will access it. In such a case, the Binary XML document 1 is read to create the coding tables 300, 310 according to the invention. These tables are then stored in memory for future uses (future accesses or modifications). It is in particular advantageous to combine this reading of the document with the first direct access to that document. Duplication of processing operations is thus avoided between the reading of the document and the first access to the Binary XML coded document 1.

In a third case of use of the invention, a data structure representing the coding/decoding tables 300, 310 is associated with and attached to the Binary XML coded document 1, the group thereof being transmitted to a remote device for processing.

Whatever the case of use envisaged, the coding tables 300, 310 corresponding to each of the documents 1 that will be modified are kept in memory. Several strategies may be implemented to limit the use of the memory.

On the one hand, management of the tables 300, 310 in memory can be applied only to certain XML documents.

On the other hand, another strategy consists of giving orders of priority to the different XML documents in order to give precedence to certain types of documents. The coding tables 300, 310 for the XML documents of least priority may be withdrawn from the memory when the amount of the memory used by the coding tables becomes too great.

This strategy may be extended to the management of these coding tables 300, 310 for their storage in several types of memory. Account is thus taken of the priority of the XML documents corresponding to the tables: thus the coding tables corresponding to the XML documents of highest priority are kept in a fast memory (for example random access memory (RAM)), whereas the coding tables corresponding to the XML documents of least priority are kept in a slower memory (for example on a hard disk).

Different measures of priority of the XML documents may be envisaged.

A first measure of priority corresponds to their degree of use. This degree of use may be measured on the basis of the time lapsed since the last modification applied to that document, on the basis of the frequency of modification of that document, or on the basis of a combination of these two measures.

A second measure of priority corresponds to the efficiency of the invention on the XML document. This efficiency may be measured on the basis of the size of the XML document (the larger the document, the greater the time saving for decoding-recoding provided by the invention). It may also be measured on the basis of the average location of the accessed content: the closer this location is to the start of the document, the lower the efficiency of the invention. It may also be measured on the basis of an estimation for the time for decoding for a conventional access and of a measurement of the time for decoding for a direct access using the invention. Lastly, this efficiency may be measured by a combination of these three parameters.

Another measure of priority consists of combining the various preceding measures.

Once these coding/decoding tables 300, 310 have been created, an event E is obtained, at the step 410, corresponding to the start of the part to be accessed.

At step 420, the location L (that is to say for example the line number of the document as represented in FIG. 1) is obtained for the event E to access within the binary XML document 1. This location may for example be obtained from an index of the binary XML document.

The following step (430) calculates the state of the decoding tables 300, 310 for that location L. Decoding tables are mentioned here because, as the Binary XML document is coded, the general process necessary to access an event is that of decoding the corresponding coded event.

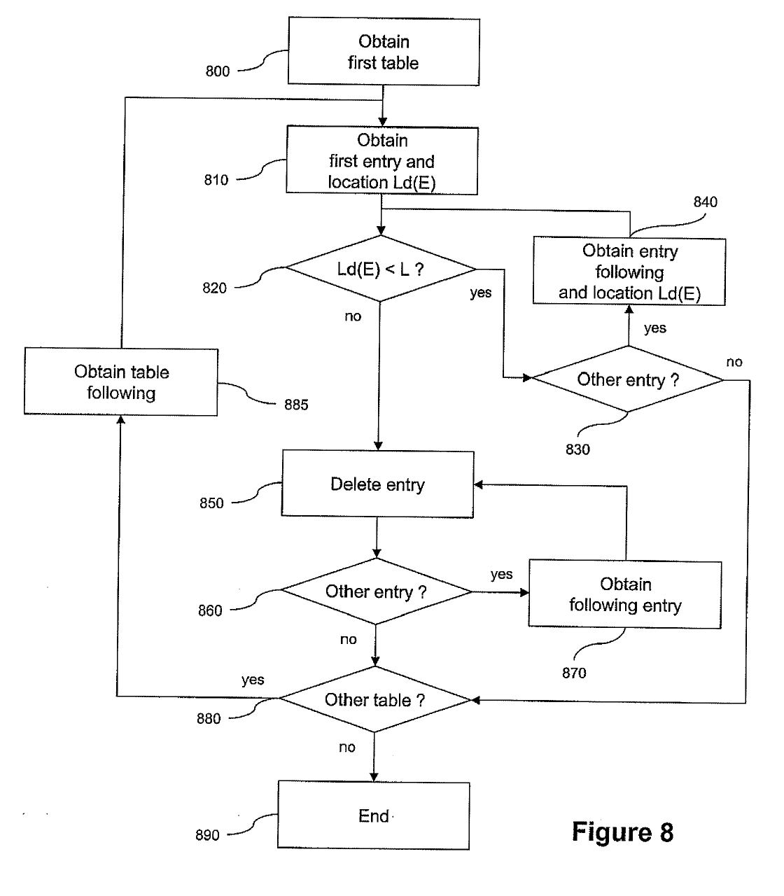

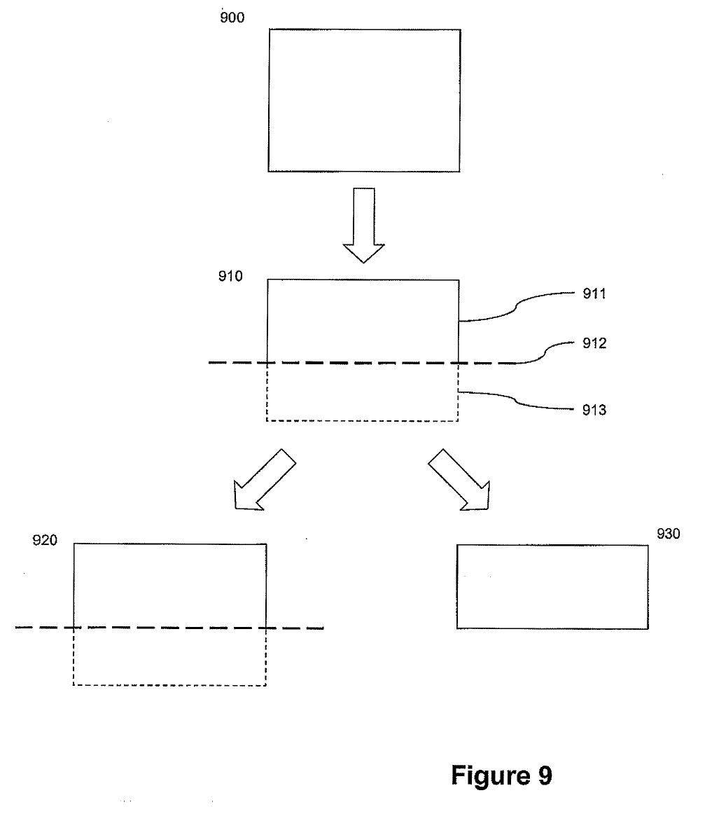

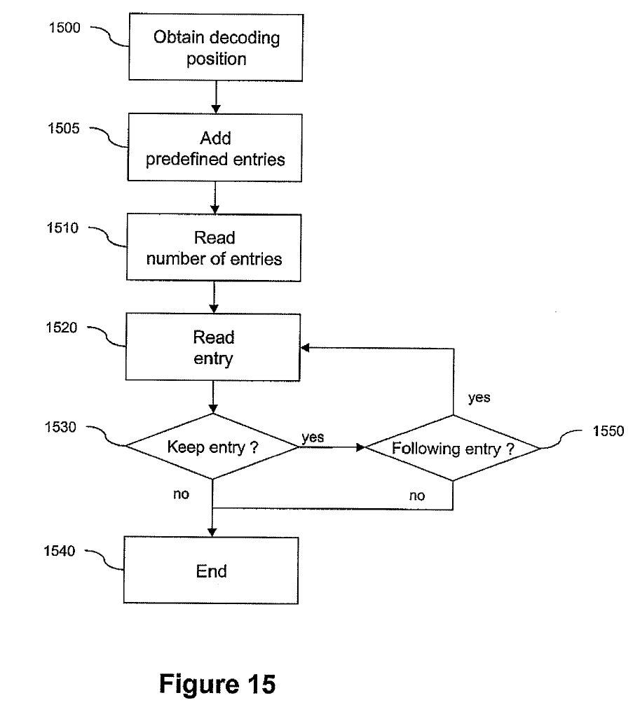

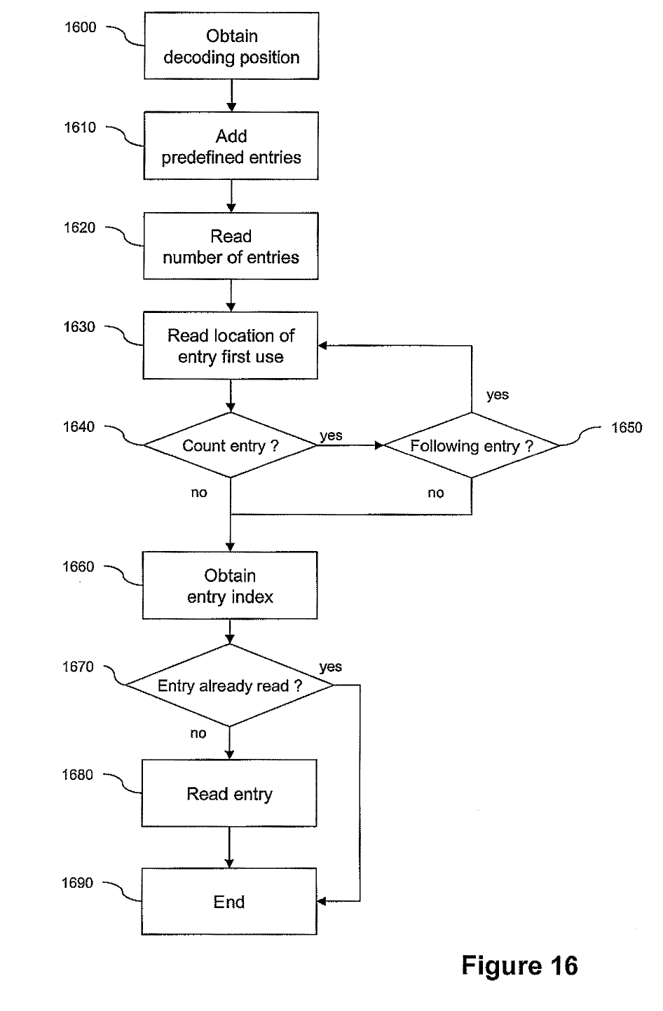

The decoding tables 300′, 310′ for the location L are calculated on the basis of the complete coding tables 300, 310 created at step 400. This calculation is in particular carried out by deleting from the coding tables 300, 310, all the entries created as from the location L. A first embodiment of this step is detailed with reference to FIGS. 8 and 9. A second embodiment is described in connection with FIG. 15. Another embodiment is detailed with reference to FIG. 16.

It is to be noted that, in practice, in order to keep the complete coding/decoding tables 300, 310 intact for future accesses or modifications of the XML document, this step 430 creates a new set of tables 300′, 310′ corresponding to the location L on the basis of the coding/decoding tables 300, 310 created at step 400.

When modification and overwriting of the document 1 is required, it will then be preferred to delete the entries directly in the initial complete tables.

Optionally, this set of tables may be specialized to better match its decoding function. More particularly, in the case of coding, the value-index (or event-index) associations are used to obtain the index on the basis of the value, whereas in the case of decoding, these associations are used to obtain the value from the index. It is thus advantageous to use representations of these associations that are optimized for their direction of use.

Thus, in the case of coding, it is advantageous to represent a table by a dictionary type structure (or hash table) associating the corresponding entry with each value. More particularly, a dictionary type structure is optimized to enable fast access to an entry on the basis of a key.

In the case of decoding, it is advantageous to represent a table by an array, the entries of the table being put in order within the array on the basis of their index, the index of an entry corresponding to its position within the array. Thus, the access to an entry on the basis of its index is carried out immediately by obtaining from the array the entry corresponding to that index.

The process ends at stop 440 in which this set of tables 300′, 310′ is used to decode the event E. This decoding is reiterated for the other elements of the part to access of the Binary XML document from the location L. The decoding is carried out in a conventional manner and ends at the end of the part to access.

It is noted that the tables 300′, 310′ thus produced contain all the information necessary for the decoding of the document as from the location L. It is thus possible to limit the decoding of the document to decoding only as from that location L without needing to decode the start of the Binary XML document 1.

If several parts have to be accessed, access may be made individually to each of those parts or, to avoid the calculations for the decoding tables 300′, 310′ it may be provided to initially access the location L that is the most upstream in the Binary XML document from among the different parts and to decode the whole of the document up to the most downstream location of the document for all the parts to access.

A description is now given of the different steps for modifying a part of a Binary XML document 1, with reference to FIG. 5. As will be seen below, modifying a binary XML document according to the invention is a particular case of the direct access to a part of a binary XML document using the invention. Below, the description will concentrate on this particular case.

It is to be noted that the two uses of the invention, for direct access and for the modification of documents, are entirely compatible and may be carried out on the basis of the same coding/decoding tables 300, 300′, 310, 310′.

The first step (500) for modifying the document 1 consists of creating coding (or decoding) tables containing information on start of use and end of use for each of their entries. This step is similar to step 400 of FIG. 4. The creation of the coding tables is described with reference to FIGS. 6 and 7 or in connection with FIGS. 13 and 14.

The two cases of use referred to above at step 400 are also envisaged in which, in the second case, it will be attempted to combine the reading of the document with the other steps of that algorithm for document modification.

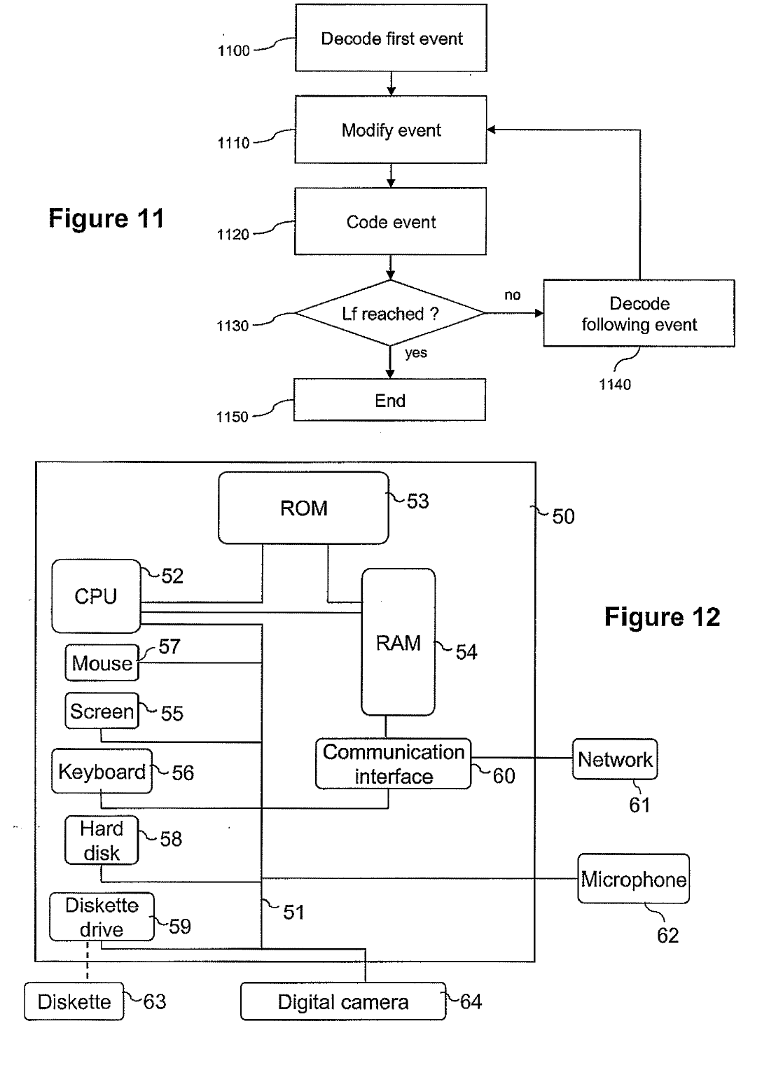

Another case of use of the invention is also provided to achieve more efficient modification of the Binary XML document 1 according to the invention. In this case, the Binary XML document 1 is regularly modified by the same device On writing the modified document as will be seen in more detail below, in particular with reference to FIG. 11, the coding tables 300, 310 according to the invention are updated and are ready to be used for the following modification. Thus the invention may be applied successively for each modification to perform in the document.

The different management strategies referred to in relation with step 400 for the direct access to the document are applicable to this step 500.

Nevertheless, the efficiency of the invention provided in the second priority measure above is estimated on the basis of the size of the XML document (the larger the document the greater the time saving given by the invention for decoding-recoding). It may also be measured on the basis of the proportion of the XML document recoded on average for each modification (or even the document portion recoded at the step 560 described below). It may also be measured on the basis of an estimation for the time for decoding-recoding for the complete document and of a measurement of the average time for modification using the invention. Lastly, this efficiency may be measured by a combination of these three parameters.

Once these coding/decoding tables 300, 310 have been created, an event E to modify is obtained at step 510. In practice, when a part of document 1 must be modified, commencement is made by the first event of the part to modify.

The modification may be the addition of the event, the deletion of the event, or the modification of the characteristics of the event.

By way of example, the XML document of FIG. 1 is modified to replace the family name of “Mary Smith” with the name “Thompson”. The event to modify is thus the text value “Smith”, to replace it by “Thompson”. It is thus a matter of replacing the content of the line 135 (“Smith”) by “Thompson”.

At the following step 520, the location L of the event E to modify within the binary XML document is obtained. This location may for example be obtained on the basis of an index of the binary XML document, as referred to above in relation with step 420.

Resuming the example of FIG. 1, the location of the event to modify is line 135.

The following step (530) calculates, in similar manner to step 430 above, the state of the coding tables 300, 310 for that location L of an event to modify. The coding tables 300′, 310′ for that location L are calculated on the basis of the complete coding tables 300, 310 created at step 500. This calculation is carried out by deleting from the coding tables all the entries created after location L, that is to say those of which the location of the first occurrence 320, 330 is subsequent to location L. This step is detailed with reference to FIGS. 8 and 9, or 15 or 16.

It is to be noted that in practice, this step creates a new set of tables 300′, 310′ corresponding to location L, on the basis of the complete tables 300, 310 created at step 500. This set of tables is identical to that which would be obtained at the time of the coding (or the decoding) of the XML document just before coding the event situated at that location L.

Next, this set of tables 300′, 310′ for the location L is duplicated to create a set of tables 300′_{(dec)}, 310′_{(dec)} for the decoding of the initial document and a set of tables 300′_{(cod)}, 310′_{(cod)} for the coding of the modified document. This is because the modification of the Binary XML document 1 requires both the decoding of a relevant portion of the initial Binary XML document 1 and the coding of that relevant portion once it has been modified in accordance with the desired modification.

A specialization of these tables similar to that referred to above in relation with step 430 may be provided. In particular, the tables 300′_{(dec)}, 310′_{(dec)} may optimize the direction of use of the associations from {coding index} to {XML element or value}, whereas the tables 300′_{(cod)}, 310′_{(cod)} may optimize the direction of use of the associations from {XML element or value} to {coding index}.

Resuming the example, location L is line 135. In the table 300, the entries 302 and 303 created for location L or later on are deleted to obtain the table corresponding to location L. In table 310, no entry is deleted, since all the entries are created prior to location L.

The modification process continues at step 540 by the calculation of the location Lf, corresponding to the end of the part to modify of the XML document 1.

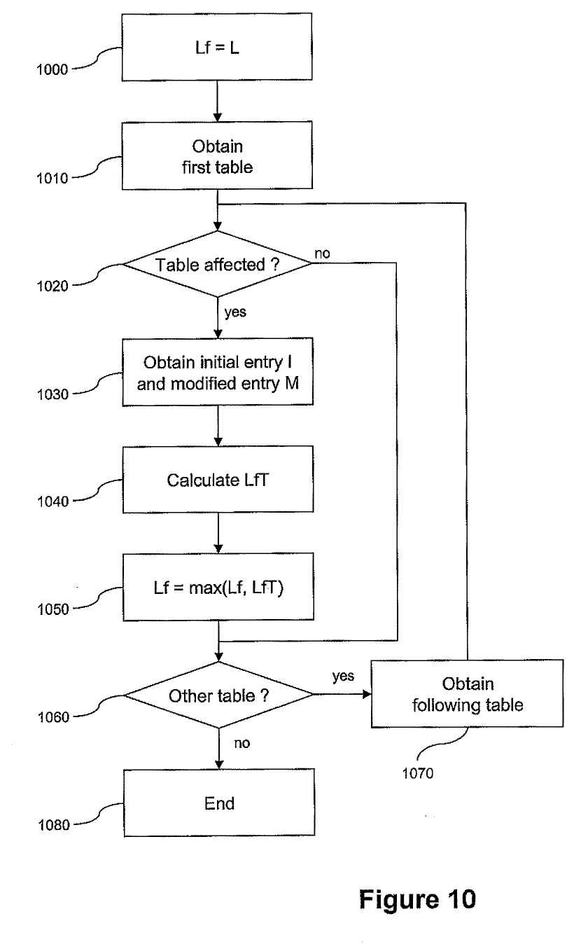

Due to the mechanisms for binary coding of XML documents, this location Lf does not necessarily correspond to the location of the event following the event E to modify. More particularly, the modification of the event E may have repercussions on the coding of the following events by modifying for example the indices associated with certain values or certain events The calculation of this location Lf is thus described later in the description with reference to FIG. 10.

Resuming the above example, the modification of the text value “Smith” of line 135 to replace it with “Thompson” only affects table 300. The initial entry corresponding to this text value is the entry 302. The modified entry corresponding to the new value (“Thompson”) does not exist in the table and the entry “Smith” 302 must be kept. The modification will thus insert a new entry in the table and move the entry 302. Consequently, in such a case the location Lf takes the value of the location of the end of the document.

Solely by way of example, in another case in which the first name “Mary” is modified to take the value “Anne”, the modification would correspond to replacing the entry 301 of the table by a new entry representing the text value “Anne”. In this case, only the modified event would be required to be recoded and location Lf would be equal to location L.

Returning to FIG. 5, once the locations for the start L and end Lf of the part to modify are known, the actual processing of the Binary XML document 1 is commenced.

First of all, at step 550, the start of the binary XML document 1 is copied to a file receiving the coded and modified version of the document. This is because the part of the binary XML document situated before location L does not undergo any modification and thus its coding in the binary XML format remains unaltered. This start of the binary XML document 1 is thus copied directly from the initial version of the document to the modified version, without performing a step of decoding or recoding.

This step 550 of direct copying enables the invention to perform a fast modification of the document: this is because the direct copying of the Binary XML document 1 is much faster than the decoding and recoding operations necessary in the prior art.

This direct copying also makes it possible to keep the initial Binary XML document 1 for the rest of the processing and for later modifications of that version if necessary.

It is however possible to modify the Binary XML document 1 in situ, that is to say without making any copy. In such a case, this step amounts to going to location L in the Binary XML document 1. In this case, the initial version of the document 1 prior to modification is not kept. Furthermore, prudence should be adopted at the following steps of the processing of the document 1 and a part of the initial document 1 that has not yet been read should not be overwritten when writing the modified document 1′ (this may occur if, for example the modification consists of adding an event). Provision may then be made to copy the remainder of the document to memory (or a varying part of the remainder), on the basis of which decoding and recoding is carried out (then the end of the document may possibly be copied as referred to below).

Resuming the example, the part of the Binary XML document corresponding to lines from 100 to 130 (inclusive) is directly copied.

Next, at step 560, the part of the Binary XML document 1 comprised between location L and location Lf is modified. This step consists of reading the initial Binary XML document 1 as from location L using the decoding tables 300′_{(dec)}, 310′_{(dec)} calculated at step 530, of applying the modifications to make to that decoded part, and of writing the modified Binary XML document I′ by recoding that modified part using the coding tables 300′_{(cod)}, 310′_{(cod)} calculated at step 530. This step is described in detail with reference to FIG. 11.

Resuming the example, the part of the Binary XML document 1 corresponding to lines 135 to 190 (inclusive) is decoded to provide lines 135 to 190 of FIG. 1. This part is then modified to include the name “Thompson” instead of the name “Smith” at line 135. Next the document is recoded taking this modification into account, which shifts the indices for coding the values “John” (index=2) and “Smith” (index=3). This modified part is written in the modified Binary XML document 1′.

The algorithm for modifying document 1 terminates at step 570 by the copying of the end of the initial binary XML document 1. In similar manner to step 550, the part of the binary XML document situated after location Lf does not undergo any modification and thus its coding in the binary XML format remains unaltered. This end of the binary XML document is thus copied directly from the initial version of the document 1 to the modified version 1′ without performing the step of decoding or recoding.

In the same way as for step 550, this step 570 of direct copying contributes to the efficiency of the invention in performing a fast modification of the document: this is because the direct copying of the Binary XML document 1 is much faster than the decoding and recoding operations necessary in the prior art.

Resuming the above example, the part of the Binary XML document situated after location Lf is empty and there is thus nothing to do at this step.

In a downgraded version of the invention, step 540 of calculating location Lf is not carried out. Consequently, step 570 is not carried out and only step 550 of direct copying contributes to the efficiency of the invention. In this version, step 560 decodes and recodes the Binary XML document 1 from location L to the end of the document. Thus, only the start of the Binary XML document is directly copied (during the step 550). The efficiency of the invention is thus less, but the processing operations and calculations are simplified.

If several parts of the Binary XML document 1 have to be modified, the calculation of the locations L and Lf is adapted.

To calculate location L, the location L(i) of each of the events “i” to modify is obtained. Next, these different locations L(i) are compared to select the one which is closest to the start of the file.

For the calculation of location Lf, the location of the end of the part Lf(i) to modify is calculated for each of the events to modify, using the algorithm described with reference to FIG. 9. Then location Lf is calculated by comparing these different locations Lf(i) and by selecting the one which is the closest to the end of the file.

The remainder of the algorithm takes place as described earlier, step 560 applying all the modifications to make to the document instead of applying just one.

A description is now given in more detail, with reference to FIGS. 6 and 7, of the creation of the coding tables in steps 400 and 500. This creation operation mainly comprises two sub-steps.

The first sub-step for the generation of the modified coding (or decoding) tables is illustrated by FIG. 6. The role of this step is to modify the initial coding tables, that is to say the coding tables by default used at the start of a process of coding the XML document, to add thereto the location information necessary for the invention.

The first step (600) consists of obtaining an initial first coding (or decoding) table 300 or 310.

Next, at step 610, all the entries in this table are marked with a location of first use 320 or 330 corresponding to the start of the file containing the XML document and a location of last use also corresponding to the start of the file. In practice, the value of these two locations is set to 0. This file start location precedes the location of the first event contained in the XML document, since the entries so marked are created before the coding (or the decoding) of that first event.

Next, step 620 verifies whether there remain other tables to process. If it is the case, the algorithm obtains another table (step 630) and processes it in turn (step 610 and following ones). If this is not the case, the algorithm terminates at step 640.

It is to be noted that this sub-step is carried out at each creation of a new coding or decoding table. Thus, if one or more new tables are created during the coding (or decoding) of the XML document, this sub-step is applied to those new tables before their use for the coding.

Once these tables 300, 310 have been provided with fields for first and last occurrences pre-filled with the value 0, this value is updated according to the associated XML document, as illustrated below with reference to FIG. 7.

Thus, the object of the second sub-step for the generation of the modified coding (or decoding) tables is to add the location information necessary for the invention for the entries in the various tables.

The first step (700) consists of obtaining a first event to code (or to decode) of the XML document 1. Next, the location of that event is obtained (step 710). This location is obtained on the basis of the current position in the coded (or decoded) Binary XML document 1. Then that event is processed (step 720). In the case of coding, the processing corresponds to coding that event. In the case of decoding, the processing corresponds to decoding that event.

The following step (730) consists of marking the entries used by that event. Two cases arise: a new entry is added to one (or both) of the tables 300 or 310, or else an existing entry is used on processing of that event. It is possible for these two cases to co-exist for the same event.

For each new entry added on processing that event, the locations of first use (320, 330) and of last use (325, 335) take the value of the location of the processed event.

For each entry already existing and used on processing of that event, the location of last use (325, 335) takes the value of the location of that event.

Next, at step 740, it is verified whether there remain other events to process. If it is the case, the algorithm obtains the following event (step 750) then processes it (steps 710 to 730). If this is not the case, the algorithm terminates at step 760.

In practice, it is efficient to combine the steps 720 and 730: during the processing of the event, at each access to a table, the locations corresponding to the entry accessed are updated.

It is also envisaged to keep the modified coding tables 300′, 310′ up to date when the Binary XML document is modified. For this, this process of adding the location information may be carried out during the coding of the modified document 1′ at the step 560, in order to obtain, at the end of the algorithm of FIG. 5, modified coding tables 300′, 310′ corresponding to the Binary XML document 1′ after modification.

In this case, it is provided for step 730 not to modify an end location if that end location is situated after Lf.

Next, at step 570, the entries of the coding tables 300′, 310′ must be completed. All the entries of the coding tables 300 and 310 of which the location of first use is subsequent to or equal to Lf are copied into the modified coding tables 300′ and 310.′ This makes it possible to add the entries corresponding to the end of the document to the coding tables 300′ and 310′.

Next, the current location in the modified Binary XML document 1′ is compared to U (which is then the current location in the initial Binary XML document 1). If these two locations are different, the size of the part recoded at step 560 has been modified and, in the tables 300′ and 310′, the locations situated after Lf or equal to Lf should be modified. For this, the difference between the current location in the modified Binary XML document 1′ and the location Lf is added to each of those locations, of first or last use (320, 325, 330, 335), located after Lf or equal to Lf.

The coding/decoding tables 300′ and 310′ are thus obtained for which the locations of first and last occurrences are correctly given for the purpose of later accesses and modifications of the associated Binary XML document 1.

A description is now made in more detail, with reference to FIGS. 8 and 9, of the steps 430 and 530 of calculating the states of the coding/decoding tables 300, 310 of the Binary XML document 1 for the particular location L.

This calculation is carried out on the basis of the modified coding tables 300, 310 created at one of the steps 400 or 500, or at step 560 when several successive modifications are made to a document. Each of the coding/decoding tables is processed.

The first step (800) consists of obtaining a first modified coding table 300, 310 and of copying it as a copied table 300′, 310T.

Next, at step 810, the first entry E of that copied table 300′, 310′ is obtained, as well as the location Ld(E) of first use associated with it.

It is to be noted that the order of the entries in the table depends on the manner of adding entries to the table. If the new entries are added from the end of the table (as is the case for the table of text values 300), the entries are in order from the start to the end of the table. If on the contrary the entries are added from the start of the table (as is the case for the grammar table 310), the entries are in order from the end to the start of the table.

At step 820, it is verified whether Ld(E) precedes the location L determined at step 420 or 520.

If this is the case, that entry E must be kept. In this case, the algorithm verifies whether other entries remain in the table (step 830) and if this is the case obtains the following entry and its location of first use Ld(E) (step 840) and continues at step 820. If at step 830, no other entry remains in the table 300′, 310′, the algorithm continues at the step 880.

If Ld(E) does not precede L (or if Ld(E) is equal to L), that entry and all the following ones must be deleted from the table 300′, 310′. For this, the algorithm continues at the step 850 in which the entry is deleted from the table. Next the step 860 verifies whether other entries remain in the table and if this is the case, the following entry is obtained at step 870 and deleted in turn (step 850). This fast deletion without test on Ld(E) is provided if a table is processed for which the entries are in order of their creation/insertion in the table (thus according to Ld(E)), and if the table is accessed by the first entry in that order.

If at step 860, no other entry remains in the coding/decoding table 300′, 310′, the algorithm continues at the step 880.

Step 880 verifies whether there remain other coding/decoding tables to process. If this is the case, the algorithm obtains the following table (step 885) then processes it (step 810 and following ones).

If this is not the case, the algorithm terminates at step 890.

The coding or decoding tables 300′, 310′ are thus obtained corresponding to those which would be obtained on conventional coding (decoding) of the document just before processing the event at the location L. The only difference is that the coding or decoding tables 300′, 310 contain, in addition, information on location of first and last use.

FIG. 9 illustrates the different states of a modified coding table during its use by the invention.

The table 900 is that created at step 400 or 500 by applying the algorithms described for example with reference to FIGS. 6 and 7. This coding table comprises a set of entries, with, for each entry, an indication of location of the first use in the XML document and (optionally) an indication of the location of the last use in the Binary XML document. Examples of such modified tables are given with reference to FIG. 3.

At one of the steps 430 or 530, a new table 910 is created on the basis of the table 900. This table 910 corresponds to the state of the coding table at a location L in the Binary XML document. This new table is created by applying the algorithm described for example with reference to FIG. 8 to table 900.

The point of location L (912) makes it possible to separate the coding table into two parts: the start (911) which corresponds to the state of the table at the coding (or the decoding) before coding the event situated at location L, and the end (913) which corresponds to the entries added to the table after that location L. The start of the table must thus be kept, whereas the end of the table must be deleted.

On the basis of this table 910, two tables are constructed. Table 920 is the one used for the decoding of the initial Binary XML document 1. It construction consists of copying table 910. As a variant, table 920 may be optimized to be made more efficient for the decoding.

Table 930 is the one used for the coding of the modified Binary XML document 1′. Its construction consists of copying the start 911 of the table 910. As a variant, table 930 may be optimized to be made more efficient for the coding.

These two tables are still constructed at step 530. On the other hand, since only the decoding table is used for the direct access to the document, only table 920 is constructed at step 430.

It is to be noted that for the needs of efficiency, it is not useful to actually create table 910: only the two tables 920 and 930 must be created. It is noted here that these two tables correspond for example to the tables 300′_{(dec)} and 300′_{(cod)} established on the basis of table 300, as referred to above.

As a variant, to optimize the algorithm, the construction of the tables may be modified. On creation of table 910, the entries contained in the end (913) of the table are not deleted, but only marked as later than the point of location L. This amounts to determining which is the last entry of the table 900 created before the location point L.

Decoding table 920 is then created by including all the entries of table 900. However, its end is positioned after the last entry created before the location point L. Next, on decoding of the document, when an entry must be added to the table, it will already be present in the right position and it will suffice to change the position of the end of the table to include that entry. This mechanism makes it possible to avoid deleting and then again adding entries to the table and thus accelerates the processing carried out by the algorithm.

On the other hand, the coding table 930 is created only on the basis of the entries of the start 911 of the table 910: this is because, as this table 930 will serve for the coding of the modified document, its entries later than the location point L will differ from those of the initial 900.

In another variants to limit the memory necessary for the algorithm, the start 911 of the table 910 may be shared by the two tables 920 and 930. This makes it possible to reduce the memory used, but to the detriment of the processing time since not only is the access to the tables 920 and 930 rendered more complex, but also the tables 920 and 930 cannot be optimized for the coding or decoding.

A description is now given, with reference to FIG. 10, of the step 540 of calculating the location Lf of the end of the part of the initial Binary XML document 1 to modify and recode.

At step 1000, the variable Lf is initialized to the value of the location L calculated at step 520.

At step 1010, a first complete and modified coding (or decoding) table 300, 310 is obtained.

At step 1020 the algorithm then verifies whether that table 300, 310 is affected by the modification to perform. For this, the algorithm determines the type of the modified XML event and the characteristic of that modified event, Depending on this, the algorithm may determine which are the tables taking part in the coding of that characteristic and thus being affected by the modification. If the table is not affected, the algorithm continues at the step 1060. In our example, the modification of a single text value only affects table 300 and not the table 310 of grammars.

If the table is affected, the algorithm determines, at step 1030, the initial entry I corresponding to the entry of the table used on coding the initial event Ei, the one to modify. It also determines the modified entry M corresponding to the entry of the table used for the coding of the modified event Em. This modified entry M is not necessarily present in the table.

Two particular cases are to take into account. If the modification corresponds to an insertion of a new event, the initial entry is empty. If, on the contrary, the modification corresponds to a deletion of an event, the modified entry M is empty.

At the following step (1040), the algorithm determines the location LfT corresponding to the end of the part of the initial Binary XML document 1 to recode for that table 300, 310 uniquely. This calculation is carried out in the following manner, depending on the existence of 1 and of M and on the location Ld(I) of first use of the initial entry I in the initial Binary XML document 1.

i) If I and M are identical, which corresponds to the modification of a characteristic of the event of which the coding does not use the table considered, the location LfT takes the value of the location L.

ii) Otherwise, and if I and M are not empty, and if the location Ld(I) is prior to the location L, three cases may arise.

The first case corresponds to the one in which the modified entry M is not present in the table. In this case, by default, the location LfT takes the value of the end of the initial Binary XML document 1, due to the addition of M which shifts the indices for the whole of the end of the document.

In the two other cases, the location Ld(M) of first use of the modified entry M is evaluated, and
if Ld(M) is prior to the location L, the coding of the modification amounts to changing an index (of that table) and the location LfT takes the value of the location L;
if Ld(M) is after the location L, two sub-cases may arise:
   if the first entry P added after location L is the modified entry M, the location LfT takes the value of the location L, since after all the coding of Em makes use of the same index of M (earlier however in the processing of the document);
   otherwise, the location LfT takes the value of the location of last use, in the table, that is the greatest for all the entries included between that first entry P and the modified entry M (inclusive of these two entries), since this is a circular swapping between the indices of the entries between P and M. As a variant, to simplify this sub-case, it is possible to consider that LfT takes the value of the end of document location.

iii) If I and M are not empty, and if the location Ld(I) is equal to the location L, two cases may arise depending on the location Lf(I) of last use of the entry I:
if the location Lf(I) is equal to the location L, two sub-cases arise:
   first of all, if the modified entry M does not exist in the table, the location LfT takes the value of the location L, resulting from a mere substitution of Ei by Em;
   otherwise, if the modified entry M exists in the table, the location LfT takes the value of the end of the initial Binary XML document, since Ei disappears from the document and is thus no longer coded thereafter.
      if the location Lf(I) is after the location L, the location LfT takes the value of the end of the initial Binary XML document.

iv) If I is empty, two sub-cases arise:
if the modified entry M is present in the table and if the location Ld(M) of first use of the modified entry M is before the location L, LfT takes the value of the location L, since this is a mere insertion of a new element Em of which the index already exists;
otherwise, LfT takes the value of the end of the initial Binary XML document, since the insertion of Em causes a shift of the indices.

v) If M is empty, two sub-cases arise:
if the location Ld(I) of first use of the initial entry I is before the location L, LfT takes the value of the location L,
otherwise, LfT takes the value of the end of the initial Binary XML document.

It is to be noted that these rules may be specified to distinguish other particular cases in which the value of LfT is close to L. The calculation rules presented here aim to obtain a good compromise between the complexity of these rules and the efficiency of the implementation of the invention.

On leaving step 1040, the location LfT is obtained corresponding to the end of the part of the initial Binary XML document 1 to recode by considering only the processed table 300, 310.

At step 1050, as end of modification location, there is stored in memory the location the furthest away in the Binary XML document 1 of that determined for the other tables already processed (Lf) and that determined for the presently processed table (LfT). Thus, if the location Lf is after the location Lf, location Lf takes the value of location LfT.

It is to be noted that modifying of the XML event may possibly affect several entries in the table. In such a case, steps 1030 to 1050 are repeated for each of the entries of the table.

Next, at step 1060, the algorithm verifies whether another table to process remains. If this is the case, that table is obtained (step 1070) then processed (step 1020 and following ones). If this is not the case, the algorithm terminates at step 1080.

The value Lf thus corresponds to the closest location to the end of the XML document 1 which is affected by the modifications envisaged.

Lastly, with reference to FIG. 11, a description is given of the actual modification of the Binary XML document 1 corresponding to step 560. The algorithm successively follows each of the locations of the events composing the part to modify.

The first step (1100) consists of decoding the first event from the initial Binary XML document 1, using the decoding tables (grammars and values) 300′_{(dec)}, 310′_{(dec)} calculated at step 530. This step is similar to the decoding step 440 in the case of direct access to a part of the Binary XML document 1.

Next, at step 1110, the algorithm modifies the event if necessary. For this, it verifies whether the event matches the one to modify. If that is the case, it applies the modification to the event.

Then, at step 1120, the event (which may possibly have been modified earlier) is coded in the modified Binary XML document 1′, using the coding tables (grammars and values) 300′_{(cod)}, 310′_{(cod)} calculated at step 530.

The algorithm then verifies, at step 1130, whether the location Lf of the end of the part to modify has been reached through comparison with the location of the event being processed in the initial XML document 1. If that is not the case, it decodes the following event from the initial Binary XML document (step 1140), then processes it in turn (step 1110 and following ones).

If the location Lf of the end of the part to modify has been reached, the algorithm terminates at step 1150.

It is to be noted that if the step 540 of calculating the location Lf is not carried out, the verification of step 1130 consists of verifying whether the end of the document has been reached.

Another implementation of the invention will now be described with reference to FIGS. 13 to 16. This is mainly distinguished by the constitution of the initial tables, referenced 300, 310 above.

In this implementation a solution is provided making it possible to easily store these initial tables with the supplementary information for first occurrence location, in the Binary XML document or in an accompanying document attached to it.

This implementation is illustrated using the EXI format. FIGS. 13 and 14 show two sections 1300, 1400 constituting a data structure representing initial coding/decoding tables (300, 310). It is this data structure, which is particularly light as will be seen below, which is attached to the Binary XML document at the time of its transmission.

The EXI format makes provision for the following coding or decoding tables:
table of the URI namespace identifiers;
tables of prefixes associated with a URI. There is one table of prefixes per URI;
tables of associated local names each of which is associated with a URI. There is one table of local names per URI;
local tables of values for text content and attributes; there is a local table of values for each element and for each attribute;
grammars or tables of structures making it possible to describe the structure of the content of an element. There are generally several structure tables for each element;
global table of values, listing the values contained in the local tables of values.

Section 1300 codes the content of the three first types of tables.

Section 1400 codes the content of the two following types. The case of the last table is dealt with later.

It is to be noted that some tables contain entries predefined by the EXI specification. In this case, these predefined entries are not stored in the data structure, since they may be reconstructed, at the decoder or at another coder, on the basis of the EXI specification and possibly coding options.

FIG. 13 details the coding of the tables of the URI namespace identifiers, of the prefixes and of the local names. In order to optimize the size necessary for the storage of these tables, and since the tables of the prefixes and of the local names are linked to the URI identifiers (and thus to the table of the URIs), all these tables are coded conjointly in section 1300.

The latter takes the form of a table and contains all the URI identifiers, as well as, for each namespace identifier, the prefixes and local names associated with it.

The first value 1301 of that table is the number of URI identifiers contained in the table of the URIs.

Next, for each URI, the table contains a set of values defining that URI identifier and the prefixes and local names which are associated with it.

Thus, sub-section 1310 groups together all the values defining a first identifier ‘URI 1’ with the prefixes and local names associated with it, and the group 1320 of values defines a second identifier ‘URI 2’ and the prefixes and local names associated with it.

The description 1310 of the first URI identifier starts with an information pointer 1311 to the location, within the coded Binary XML document, at which that URI is defined; generally the document start and at the very least at the time of its first occurrence in the document.

In the case in which the coding used in the XML document does not align the coded values with the byte limits (case referred to as “bit-packed”), the level of precision of the pointers used is the bit. That is to say that they indicate, within the byte pointed to, at which bit the referenced value commences. In the byte-aligned case (each new coded value recommencing at a new byte), only the byte is pointed to. More generally, the format of the pointers depends on the mode or options for coding used.

There then follows the number 1312 of prefixes associated with that identifier ‘URI 1’ and the number 1313 of local names associated with that same URI.

Next, if the number 1312 of prefixes associated with that URI is not zero, sub-section 1310 includes the list of the prefixes, each prefix being described by a pointer 1314 to the position of its definition within the Binary XML document, that is to say generally its first occurrence. Thus, the first prefix associated with the first URI is described by its pointer (1314).

After the list of the prefixes, the list of the local names associated with the URI 1 is coded, each local name being described by a pointer 1315 pointing to its first occurrence in the coded binary document (position of its definition). Thus, the first local name associated with the first URI is described by its pointer (1315).

The sub-section 1320 of description of the second identifier ‘URI 2’ is constructed in similar manner.

It can be seen here that the pointers 1314, 1315, 1324, 1325 used have a double role: not only that of giving the indication of first occurrence used for the implementation of the invention, but also that indicating where to find the sufficient information to create a complete coding/decoding table entry in accordance with the EXI format.

This is because, as a coding table must able to be reconstructed during the decoding, all the entries thereof which are not predefined in the specification or on the basis of the coding options (such as in the case of the coding using a description of XML schema type), must be coded in the XML document itself. This constraint is thus used to describe each entry (that is not predefined) of a table using a pointer (or several, according to the complexity of the entry) to the coding of that entry in the XML document.

Thus, by virtue of this second role, the data structure comprises a low amount of information compared with the complete tables of FIG. 3. The later transmission of this structure with the coded document is thus weakly penalized.

An important point for the invention is the use of pointer to values of the coded document. More particularly, as a coding dictionary must be able to be reconstructed during the decoding, all the entries of that dictionary which are not predefined must be coded in the binary XML document. Thus, the invention describes each entry (that is not predefined) of a dictionary by using a pointer (or several, according to the complexity of the entry) to the coding of that entry.

It is noted that this structure may be constituted progressively with the coding/decoding of a first document; at each creation of a new entry in one of the coding/decoding tables 300, 310, the corresponding pointer is added into that structure and the counters (1301, 1312, 1313, 1322, 1323, etc.) are incremented which work well.

As a variant, this structure may be constructed from coding/decoding tables 300, 310 already completed with the information on first and last occurrence.

For this, it is also envisaged, in sections 1300 and 1400 and at the first occurrence pointers for the entries, to provide a complementary pointer for last occurrence, corresponding to columns 325 and 353 of FIG. 3.

FIG. 14 details the coding of the local tables of values and of structures tables. These tables are in particular associated with qualified names, that is to say names defined by a namespace and a name in that space. By virtue of the grouping together that may be carried out on the basis of those qualified names, these tables are conjointly coded in section 1400, in table form.

Section 1400 contains the description of all these values/structure tables.

A first sub-section 1410 describes all the qualified names QName having at least a value table or a structure table associated. This first sub-section 1410 commences with the number 1411 of qualified names concerned by the different values/structure tables.

Next, for each qualified name present, three values are described. Thus, for the first qualified name ‘QName 1’, these three values are stored in the fields 1412, 1413 and 1414.

The first value 1412 corresponds to the description of that qualified name. This description is made by coding the coding index of the URI and the coding index of the local name of that qualified name. These indices correspond to those provided in the coding/decoding tables associated with section 1300. They will in particular be re-associated with the URI and corresponding local name, by the decoder, when the latter has reconstituted the decoding tables using section 1300. These indices are preferably coded with a constant coding size, to enable a fast search for a qualified name within that table, as explained below.

The second value 1413 is a pointer to the description of the table of values associated with that qualified name. Thus, for the first qualified name ‘QName 1’, this value indicates the position, in section 1400, of the value 1431 described below.

The third value 1414 is a pointer to the description of the tables of structures that is associated with that qualified name. Thus, for the first qualified name ‘QName 1’, this value indicates the position, in section 1400, of the value 1421 described below.

The second qualified name ‘QName 2’ is next coded using the values 1415, 1416 and 1417 as represented in FIG. 14.

For a decoder, the access to the tables associated with a qualified name may thus be made by going through sub-section 1410 of that table 1400 and by checking, for each qualified name description, if it matches the qualified name searched for.

This access may be optimized by sorting the qualified names (for example by order of URI index, then by order of local name index), which enables a more efficient dichotomous search in sub-section 1410.

Further to 1410, the second sub-section 1420 describes all the tables of values and structures for the qualified names which have been listed in the first sub-section, one qualified name after the other.

Within 1420, the third sub-section 1430 includes all the description information of the table of values for a qualified name, here the first qualified name ‘QName 1’.

Thus, the first value 1431 gives the number of values associated with that first qualified name, that is to say the number of entries in the local table of the values associated with that qualified name. Next, each value is defined by a pointer 1432 pointing to its description in the coded XML document, that is to say by the position of the first occurrence in the coded EXI stream.

Further to 1430, the entries of sub-section 1420 describe the structures tables associated with the first qualified name ‘QName 1’.

Thus, the first value 1421 describes the number of structures (grammars) tables associated with the first qualified name ‘QName 1’.

Next, each structures table is described. Thus the first structures table ‘Grammar 1’ of the first qualified name ‘QName 1’ is described by sub-part 1440.

This sub-part 1440 contains a first value 1441 which correspond to the number of entries (termed productions in the EXI format) of that first structures table.

Each entry/production is described by three values. Thus, the first entry ‘Production 1’ of that first structures table ‘Grammar 1’ is described by sub-part 1450.

The first value 1451 of that sub-part describes the type of structure corresponding to that entry, for example that type may correspond to a start element (production of SE type according to the EXI specification), to an attribute (production of AT type), to a comment, etc.

The second value 1452 of that sub-part is a pointer to the first occurrence of that structure in the coded EXI document.

This reference 1452 with the use of a pointer makes it possible both to define the first occurrence for that entry/production, and also to specify the value of the entry/production in certain cases. Thus, for a start element SE, this value makes it possible to define the first occurrence of that start element as well as the qualified name of that element. In the same way, for an attribute, this value makes it possible to define the first occurrence of that attribute as well as the qualified name of that attribute.

The third value 1453 of that sub-part is an indication of the following structures table to use, in accordance with what is prescribed by the EXI specification. This value may be, for example, an index in the group of structures tables that are associated with that qualified name.

The data structure may be optimized in particular to speed up going through it. In one embodiment, the qualified names are then grouped together according to the nature of the corresponding XML item. Knowing for example that according to the specification EXI distinguishes the elements from the attributes and that the attributes have no structures tables (grammars) associated, it can be provided to divide sub-section 1410 into a first sub-part containing the qualified names associated with an element, and into a second sub-part containing the qualified names associated with an attribute. For this second sub-part, only the two first values 1412 and 1413 (the description of the qualified name and the pointer to the description of the table of associated values) are present.

The same is then performed for sub-section 1420, and no information on the structures tables is coded for the qualified names corresponding to attributes.

It is to be noted that the global table of values is not stored in the above description.

This is because the reconstruction of this global table may be made on the basis of the description of the local tables of values. This is because the EXI specification defines the global table as being constituted by the collection of the values contained in the local tables. However, to obtain a global table in conformity with the initial tables, and in particular having regard to the coding indices automatically allocated by the EXI specification, on reconstruction of that global table, the values should be placed in the order described in the specification, that is to say the order of appearance of those values in the coded XML document. For this, it suffices to sort all the values on the basis of their position in the coded XML document and to generate the corresponding coding indices.

However, as this method makes a partial reconstruction of the global table of values costly, a compromise between compression and efficiency is obtained by coding the global table of values. This may be carried out by coding for example in a new section, the number of values contained in that table, as well as, for each value, the pointer to the description of that value in the EXI stream.

The data structure constituted by sections 1300 and 1400 (and possibly by the section for the global table) may be either coded in the Binary XML document itself, for example by adding those tables at the document end, or be coded in an accompanying document appended to the coded XML document.

In order for a decoder to be easily able to access those sections, two pointers indicating their position are thus added. If these sections are coded in the XML document itself, those pointers are added at the document end, thus, they are directly accessible from the end of the document. If these sections are coded in an accompanying document, the pointers are preferably added at the start of that accompanying document.

A description will now be made of the use of this data structure by a coder/decoder to access a part of the coded XML document, with reference to FIGS. 15 and 16.

Although only the generation of a coding/decoding table is described below, it is applied to all the tables described in the sections of the data structure.

FIG. 15 details the algorithm for decoding an initial coding or decoding table according to the invention, for the purpose of reconstructing a coding or decoding table corresponding to the state of that table for a specific location L in the coded XML document. This algorithm may be implemented at aforementioned steps 420/430 or 520/530, in particular applied to the structure of FIGS. 13 and 14.

As set out previously in connection with FIGS. 4 and 5, such a reconstructed decoding table enables the coded XML document to be directly decoded from that location L. The reconstruction of a coding table is useful in particular in the case where it desired to modify a part of the coded XML document.

At the first step 1500, the decoding position in the coded XML document is obtained, that is to say the location L of the start of the part to access in the EXI stream.

The following step 150 consists of adding all the entries predefined by the EXI specification to that decoding table in course of reconstruction, for example productions by default in the case of the grammars.

Processing continues at step 1510 at which the number of entries of the decoding table to decode is decoded, by retrieving one of the numbers 1301, 1312, 1313, 1322, 1323, 1411, 1431, 1421, 1441, etc. depending on the table being processed.

Thus, for example, in the case of the table of the URIs, this number is retrieved from field 1301. In the case of the table of the local names of the first URI this number is in field 1313. In the case of the table of the values for the first qualified name ‘QName 1’, this number is in field 1431. In the case of the first structure table of the first qualified name, this number is in field 1441.

Next, at the following step 1620, if the number of entries of the table to decode is not zero, a first entry from that decoding table is decoded.

For example, in the case of the URIs table, this entry is the value 1311. In the case of the table of the local names of the first URI, this entry is the value 1315. In the case of the table of the values for the first qualified name, this entry is the value 1432. In the case of the first structure table of the first qualified name, this entry is composed by the values 1451, 1452 and 1453.

At the following step 1530, it is verified whether this entry must be kept. For this, the pointer of the first occurrence of the entry in the coded document is compared with the pointer defining the decoding position L obtained at step 1500 (thus the start of the part to access).

For example, in the case of the table of the URIs, the pointer 1311 is retrieved. In the case of the table of the local names of the first URI the pointer 1315 is retrieved. In the case of the table of the values for the first qualified name, the pointer 1432 is retrieved. In the case of the first structure table of the first qualified name, the pointer 1452 is retrieved.

If the first occurrence pointer of the entry is greater than the decoding position L, this means that this entry was created after the position of start of decoding. This entry must therefore not be included in the reconstruction table.

Thus, if at step 1530, the entry must not be kept, that entry is not added to the table, and the algorithm terminates at step 1540.

In the opposite case, the entry is added to the table, by retrieving all the information on the entry in the EXI document at the location defined by the pointer. This information gives in particular the name of the item concerned and the associated coding index. The algorithm then continues at step 1550.

Step 1550 consists of considering the following entry. If there is no following entry, the algorithm terminates at step 1540. Otherwise, the following entry is read (step 1520) and processed in turn.

To determine whether there is a following entry to consider, the algorithm compares the number of entries read at an iteration of step 1520 with the total number of entries of the table read at step 1510. If the number of entries read at step 1520 is less than the total number of entries in the table, there is a following entry to consider. Otherwise, there is no following entry to consider.

The decoding table (and respectively the coding table) is thus ready to assist the EXI decoder (respectively the EXI coder) to decode the coded XML document (respectively to code the new XML document in an EXI stream) from the position specified at 1500.

It may be noted here that the entries are generally coded in their order of addition to the table. This coding order makes it possible to implicitly code, within the data structure 1300+1400, the order of the entries in the table. Thus, when an entry is verified as being created for a later position than the current decoding position, all the following entries are also later and it is thus not necessary to consider them, which reduces the processing operations performed.

However, in the case in which this implicit order is not kept within the data structure, for example because a lexical sorting operation has been carried out, use is made of the number of entries determined at step 1510 to test, in a loop, all the entries of the structure.

As a variant, FIG. 16 details an algorithm for partial decoding an initial coding or decoding table according to the invention, for the purpose of reconstructing a coding or decoding table corresponding to the state of that table for a specific location in the coded XML document. Relative to the algorithm described above, this solution consists of only reconstructing the part of the decoding table that is necessary for the decoding of an item of information of the coded XML document. Thus the computing time necessary for reconstructing the decoding tables is reduced.

In particular, the decoding of the entries of a decoding table is only carried out when it is necessary.

In detail, at a first step 1600, the decoding position L in the coded XML document is obtained, that is to say generally the start of the part to access.

At the following step 1610, all the entries predefined by the EXI specification are added to that decoding table.

Next, the following steps consist of calculating the number of entries present in the table corresponding to the current location in the document, that is to say for the location of the part of the coded XML document in course of decoding.

This number of entries present in the table corresponding to the current location in the document is necessary to be able to decode the coding index of an entry in that table. This is because the coding index of an entry in that table is coded on the basis of the number of entries present in the table.

For this, at step 1620, the number of entries in the decoding table is decoded in similar manner at step 1510.

Next, at step 1630, for a first entry of that decoding table, the information on first occurrence location for the entry is decoded, using the pointers provided in the data structure 1300+1400.

At step 1640, it is verified whether this entry must be counted, that is to say whether its location of first use is prior to the current location L in the document.

If this is the case, the algorithm checks whether there is a following entry (step 1650) and if yes, process it (i.e. return to step 1630).

At the issue of the two negative cases (outputs NO from steps 1640 and 1650), the number of entries counted is the number of entries in the current decoding table, it being understood that if the entries are re-sorted in the data structure, all the entries are processed with a loop set up on the basis of the number of entries retrieved at step 1620.

Steps 1620 to 1650 are similar to steps 1510 to 1540, except that the first ones merely count the entries present in the table, whereas the second ones actually create those entries in the table.

In these two negative cases, the algorithm continues at step 1660 at which decoding is performed of the coding index of the entry to use for the decoding of the current part of the coded XML document. This index is directly decoded in the coded EXI stream by first of all taking the first coded item in the part to access. The decoding of this index uses the information on the number of entries present in the table, counted by steps 1620 to 1650.

At step 1670, it is then checked whether that entry has been already read. If this is the case, the algorithm terminates at 1690.

If this is not the case, the entry is read at step 1680 and its definition is retrieved from the coded XML document using the pointer for the entry contained in the data structure. The processing operations carried out at this step are similar to those of step 1530.

The algorithm then terminates at step 1690: the entry necessary for the decoding having itself been decoded, the decoding of the current part of the coded XML document can continue with the decoding of the next part.

On later use of that same decoding table, step 1660 may be again looped to obtain the index of the entry corresponding to a new part of the XML document to code.

Thus, the decoding continues by obtaining the following part of the XML document, until the part to decode has been fully gone through.

Consequently, steps 1600 to 1650 are only carried out once for a decoding table, in particular at its first use.

In this embodiment of the invention, it is thus found that only the entries of which the corresponding indices are present in the part to decode, are actually decoded and added to the table used for the decoding.

In connection with FIG. 13, an embodiment for the coding of the URI identifiers and associated tables has been presented above. This embodiment does not enable direct access to each URI identifier as is obtained in FIG. 14 for the other tables.

However, this embodiment has the advantage of requiring less memory space and the indirect access is not a penalty since in general the number of URIs used in an XML document is limited and it is thus generally necessary to fully reconstruct the URIs table.

According to an alternative, a slightly different organization of section 1300 may be used to be able to directly access each URI, for example an organization inspired by section 1400, with, in particular, a first sub-section listing the different URI identifiers and associating with them one or several pointers to tables of a second sub-section. This configuration facilitates the partial reconstruction of the tables of prefixes or local names associated with a URI.

A first solution is to associate, with each URI, a pointer to the description of that URI. Thus, for the first URI in FIG. 13, that pointer would indicate the value 1311 which would be contained in the second sub-section.

A second solution is to associate, with each URI, a pointer for the prefixes table and a pointer for the local names table. Thus, for the first URI of FIG. 13, the pointer for the prefixes table would indicate the value 1312, whereas the pointer for the table of local names would indicate the value 1313, these two values being in the fields of the second sub-section.

Thus, by virtue of the data structure and the associated processing operations, it is possible to transmit the Binary XML document at lower cost accompanied by initial tables, and enable its exploitation by the implementation of the invention on any recipient processing device.

With reference to FIG. 12, a description is now given by way of example of a particular hardware configuration of a device for accessing or modifying a Binary XML document adapted for an implementation of the method according to the invention.

An information processing device implementing the present invention is for example a micro-computer 50, a workstation, a personal assistant, or a mobile telephone connected to different peripherals. According to still another embodiment of the invention, the information processing device takes the form of a camera provided with a communication interface to enable connection to a network.

The peripherals connected to the information processing device comprise for example a digital camera 64, or a scanner or any other means of image acquisition or storage, that is connected to an input/output card (not shown) and supplying multimedia data, possibly in the form of XML documents, to the information processing device.

The device 50 comprises a communication bus 51 to which there are connected:
A central processing unit CPU 52 taking for example the form of a microprocessor;
A read only memory 53 in which may be contained the programs whose execution enables the implementation of the method according to the invention;
A random access memory 54, which, after powering up of the device 50, contains the executable code of the programs of the invention as well as registers adapted to record variables and parameters necessary for the implementation of the invention, in particular the tables 300, 310 of FIG. 3;
A screen 55 for displaying data and/or serving as a graphical interface with the user, who may thus interact with the programs according to the invention, using a keyboard 56 or any other means such as a pointing device, for example a mouse 57 or an optical stylus;
A hard disk 58 or a storage memory, such as a memory of compact flash type, able to contain the programs of the invention as well as data used or produced on implementation of the invention;
An optional diskette drive 59, or another reader for a removable data carrier, adapted to receive a diskette 70 and to read/write thereon data processed or to process in accordance with the invention; and
A communication interface 60 connected to the telecommunications network 61, the interface 60 being adapted to transmit and receive data.

In the case of audio data, the device 50 is preferably equipped with an input/output card (not shown) which is connected to a microphone 62.

The communication bus 51 permits communication and interoperability between the different elements included in the device 40 or connected to it. The representation of the bus 51 is non-limiting and, in particular, the central processing unit 52 unit may communicate instructions to any element of the device 50 directly or by means of another element of the device 50.

The diskettes 52 can be replaced by any information carrier such as a compact disc (CD-ROM) rewritable or not, a ZIP disk or a memory card. Generally, an information storage means, which can be read by a micro-computer or microprocessor, integrated or not into the device for accessing or modifying a Binary XML document, and which may possibly be removable, is adapted to store one or more programs whose execution permits the implementation of the method according to the invention.

The executable code enabling the accessing or modifying device to implement the invention may equally well be stored in read only memory 53, on the hard disk 58 or on a removable digital medium such as a diskette 63 as described earlier. According to a variant, the executable code of the programs is received by the intermediary of the telecommunications network 61, via the interface 60, to be stored in one of the storage means of the device 50 (such as the hard disk 48) before being executed.

The central processing unit 52 controls and directs the execution of the instructions or portions of software code of the program or programs of the invention, the instructions or portions of software code being stored in one of the aforementioned storage means, On powering up of the device 50, the program or programs which are stored in a non-volatile memory, for example the hard disk 58 or the read only memory 53, are transferred into the random-access memory 54, which then contains the executable code of the program or programs of the invention, as well as registers for storing the variables and parameters necessary for implementation of the invention.

It will also be noted that the device implementing the invention or incorporating it may be implemented in the form of a programmed apparatus. For example, such a device may then contain the code of the computer program(s) in a fixed form in an application specific integrated circuit (ASIC).

The device described here and, particularly, the central processing unit 52, may implement all or part of the processing operations described in relation with FIGS. 3 to 11, to implement the method of the present invention and constitute the device of the present invention.

The preceding examples are only embodiments of the invention which is not limited thereto.

In particular, although the detailed embodiment shows the modification of an encoded document, the invention also applies to the access to a part of said document. In this respect, steps E500-E530 are performed, and then the part starting from location L within the document is decoded in step E560 using the decoding table constructed at step E530. And the decoded part is then displayed to the user.

As explained above, the start (portion) of the document (preceding location L) is not decoded.”

Further, the invention also applies in the case in which elements of the document are coded independently, for example the elements coded using the “self-contained” EXI option. With this option, independent coding of one or several XML events may be made, each event being self-describing. In this case, several sets of tables are coded: a first set for the main part of the document, and a set for each element coded independently.

1. A method of accessing part of a document on the basis of a coded version of said document, comprising the decoding of the part to access using at least one decoding table having entries, each of which associating a non-coded item with a coded field, the method further comprising a step of forming said at least one table for the decoding on the basis of:
at least one initial coding/decoding table grouping together entries corresponding to a plurality of coded fields of the document and comprising, for at least one entry, an indication of the first occurrence, within the coded document, of the item associated with the entry; and
a location, within the coded document, of a first coded field of said part to access.

2. A method according to claim 1, in which said forming step comprises:
determining said location, within the coded document, of the first coded field of said part to access; and
selecting the entries of the at least one initial table of which the first indicated occurrence is located, within the coded document, before said determined location, so as to form said at least one coding/decoding table;
said decoding of said part to access being carried out using the selected entries.

3. A method according to claim 2, in which said selection comprises the deletion, from said at least one initial table, of the entries of which the first indicated occurrence has a location subsequent or equal to said determined location so as to form said at least one table for the decoding.

4. A method according to the preceding claim, comprising a step of duplicating said at least one initial coding/decoding table before said selecting step.

5. A method according to claim 1, in which the entries of the at least one initial table comprise a reference for the location, in said coded document, of the definition of the associated coded field.

6. A method according to the preceding claim, in which said at least one initial table is transmitted attached to said coded document.

7. A method according to claim 5, in which the forming step comprises:
selecting at least one entry from the initial table of which the first indicated occurrence is located, within the coded document, before said location of a first coded field;
accessing at the location referenced in said selected entry and decoding the coded data at said location to form an entry of the decoding table.

8. A method according to the preceding claim, comprising a step of obtaining an item of coded data from said part to decode, and the steps of selecting, accessing and decoding the entry associated with that item of coded data are carded out further to said obtaining if no entry associated with said item of coded data is present in said decoding table.

9. A method of modifying part of a document on the basis of a coded version of said document, comprising:
a step of accessing said part to access for modification, according to the method of claim 1; and
said decoding of the part to access being followed by a modification of said decoded part and coding of said modified part into a modified coded document.

10. A method according to claim 9, in which the accessing step comprises determining said location of the first coded field of said part to access, the modifying method comprising a step of copying the start of the coded document up to said determined location of the first coded field.

11. A method according to the preceding claim, comprising a step of determining the location, within the coded document, of the last coded field to modify;
said decoding of the part to modify being continued up to said location of the last coded field to modify.

12. A method according to the preceding claim, in which, further to the decoding, to the modification and to the coding of the part then modified, the end of the coded document is copied as from said location of the last coded field to modify.

13. A method according to claim 9, in which at least one entry of said at least one initial coding/decoding table comprises an indication of the last occurrence, within the coded document, of the item associated with the entry.

14. A method according to the preceding claim, comprising a step of constructing the at least one initial coding/decoding table said constructing comprising:
a preliminary step of modifying at least one basic coding/decoding table by the addition, for each entry, of an indication of first occurrence taking the value of the document start location and of an indication of last occurrence taking the value of the document start location; and
a later step of processing at least one item of said document, comprising modifying the indication of last occurrence of the entry corresponding to said item, on the basis of the location, within the coded document, of the coded field corresponding to said processed item.

15. A method according to claim 9 when the accessing method is dependent from claim 2, in which said selection of the entries comprises deleting, from said at least one initial table, the entries of which the first indicated occurrence has a location subsequent to said determined location so as to form said at least one table for the decoding or coding, the method comprising duplicating the at least one table so obtained so as to possess at least one coding table and at least one decoding table.

16. A data structure associated with a document coded using at least one coding table having entries, each of which associating a non-coded item with a coded field, the data structure comprising, for entries of the at least one coding table, a reference for the location, in said coded document, of the definition of each entry, and an indication of first occurrence of the item associated with the entry.

17. A data structure according to the preceding claim, in which, said reference and said indication are conjointly made by means of the same pointer to said first occurrence.

18. A device for accessing or modifying a part of a document on the basis of a coded version of said document, comprising means for decoding said part to access using at least one coding/decoding table having entries, each of which associating a non-coded item with a coded field, characterized in that it comprises means for forming said at least one table from:
at least one initial coding/decoding table grouping together entries corresponding to a plurality of coded fields of the document and comprising, for at least one entry, an indication of the first occurrence, within the coded document, of the item associated with the entry; and
a location, within the coded document, of a first coded field of said part to access.

19. A device according to the preceding claim, in which said forming means comprise:
means for determining the location, within the coded document of the first coded field of said part to access;
means for selecting the entries of the at least one initial table of which the first indicated occurrence is located, within the coded document, before said determined location, so as to form said at least one coding/decoding table for the decoding; and
the decoding means being adapted to decode said part to access using the selected entries.

20. A means of information storage that is readable by a computer system, comprising instructions for a computer program adapted to implement the method of accessing or modifying according to claim 1 or 15, when the program is loaded and executed by the computer system.
